(19) United States
(12) Patent Application Publication
(10) Pub. No.: US 2015/0295872 A1
(43) Pub. Date: Oct. 15, 2015

(54) AGGREGATING DIGITAL FILE AND MESSAGE CONTENT INTO A SINGULAR AND CHRONOLOGICALLY ORGANIZED CONVERSATION

(71) Applicants: Kent P. Hawryluk, Indianapolis, IN (US); Jeffrey S. Goens, Indianapolis, IN (US); Colin G. Mathews, Indianapolis, IN (US)

(72) Inventors: Kent P. Hawryluk, Indianapolis, IN (US); Jeffrey S. Goens, Indianapolis, IN (US); Colin G. Mathews, Indianapolis, IN (US)

(21) Appl. No.: 14/378,424

(22) PCT Filed: Sep. 7, 2012
(86) PCT No.: PCT/US12/54286

§ 371 Date: Apr. 17, 2015

Related U.S. Application Data
(60) Provisional application No. 61/598,104, filed on Feb. 13, 2012.

(51) Int. Cl. H04L 12/58; G06F 3/0484; H04L 29/06

(52) U.S. Cl. CPC H04L 51/16; H04L 67/42; G06F 3/0484

(57) ABSTRACT

Files and messages, such as would be exchanged by participants in a negotiation, can be organized in a singular record of updates that can easily be reviewed and understood by any of the participants in the interaction. Such a singular record can be stored in a highly secure manner that can allow the participants in the interaction to exchange confidential information without the concern that it will be accessed by an unauthorized third-party, either while in transit or due to insecure computer systems.

### CROSS-REFERENCE TO RELATED APPLICATIONS

This application claims priority from U.S. Provisional Patent Application Ser. No. 61/598,104, filed on Feb. 13, 2012, and having the title Method for Aggregating Digital File and Message Content into a Singular and Chronologically Organized Conversation. The disclosure of that application is hereby incorporated by reference in its entirety.

### BACKGROUND

Traditionally, interactions such as negotiations have taken place in a face-to-face or telephonic format, in that participants can exchange and discuss information with one another in real time. While these types of traditional interactions still take place, a large and ever-increasing portion of interactions are currently being performed using remote, electronic means, particularly email. Unfortunately, there are several drawbacks to email as a medium for interactions. For example, interactions that take place over email have a tendency to break down into multiple, parallel threads as participants respond to messages sent at various previous points in the transaction. This problem is only compounded for interactions that involve the exchange of documents. As an email interaction splinters into multiple threads, the documents being exchanged in the interaction will often also splinter into different versions, one for each thread. Individual participants in the interaction can then comment or suggest modifications to the different documents in the different threads, leading to a welter of potentially inconsistent documents that must, somehow, be combined into a unified final version as the interaction draws to a close.

Another drawback of email interaction is an inherent lack of security. In email interactions, each participant in the interaction will have his or her own copies of all documents and messages that he or she has been sent in the interaction. This leads to a multiplication of points of failure in the interaction, such that if the security of the computer systems used by any of the participants is compromised, the security of the entire interaction is breached. Further, at a more basic level, any messages sent between participants in email interactions have to pass through a large number of intermediaries (e.g., mail servers, third-party routing servers, etc.), each of which represents a point of attack where the security of the interaction could be compromised. To some extent, these security issues could be addressed by encrypting email messages and documents sent during email interactions. However, this would require each sender and recipient to manage a combination of public, private, or shared encryption keys in a common system with other participants in the interaction. It would also often require each of the senders to install security software on their own computer systems, adding a layer of administrative complication that many participants in email interactions might wish to avoid.

Some technology exists that can address some of these deficiencies. For example, document repositories, some of which can maintain version control and other information about files, can be used to avoid documents splintering into multiple incompatible versions. Similarly, cloud-based file transfer or storage utilities (e.g., Dropbox) can be used to address some aspects of the security issues raised by communicating confidential information over email. However, these alternative technologies have their own drawbacks. For example, document repositories may contain information beyond simply what is involved in an interaction, and so using them to share information may require cumbersome data segregation and/or security policies. This can complicate both the maintenance of the repositories and the processes of provisioning and providing access to the repository. Similarly, while cloud-based file transfer or storage services may be more secure in transit than email, they are often less convenient, especially in interactions where much of the communication is in the form of short messages or tasks, rather than massive files. Ironically, they can also be too convenient—often allowing participants in a conversation to share access to the repository or the documents in it inappropriately. Even to the extent these issues (and similar issues with these or other technologies) can be overcome, existing technologies that could be used in place of email are generally point solutions and do not have nearly the universal acceptance enjoyed by email. That is, they are suitable for some, but not all, of the functions email is generally used for. As a result, using them is generally much less convenient than using email, as it requires both manipulation of multiple (potentially incompatible) tools and an agreement with everyone else in the interaction that they will use those tools as well.

In light of the above, despite its drawbacks, email remains the dominant tool for interactions involving parties at multiple remote locations. Accordingly, there remains a long-felt but unmet need for technology that can be used to facilitate the exchange of information between widely separated parties while addressing one or more of the drawbacks associated with the existing art.

### SUMMARY

Disclosed herein are techniques which can be used in a variety of settings, including facilitation of interactions over an electronic medium, and maintaining the convenience of email while addressing some of the security and usability problems associated with email interactions. For example, aspects of the teachings set forth herein could be used in a computer-implemented method of presenting a singular record of communications in an interaction depicting a course of updates in the interaction, where the record is easily accessible to and understandable by all participants in the interaction.

Of course, the teachings set forth herein are susceptible to being used in contexts other than computer-implemented methods as described above. For example, the teachings of this disclosure could be used to implement a machine that maintains records of all communications in an interaction, stores such records in a highly secure manner, and presents such records in a singular format that enables all participants in the interaction to easily understand what has taken place, even if they joined the interaction after its inception. Various other methods, machines, and articles of manufacture could also be implemented based on this disclosure by those of ordinary skill in the art without undue experimentation, and should not be excluded from protection by claims included in this or any related document.

### BRIEF DESCRIPTION OF THE DRAWINGS

The drawings and detailed description that follow are intended to be merely illustrative and are not intended to limit the scope of the invention as contemplated by the inventor.

FIG. 1 illustrates an interface that could be presented to an individual engaged in an interaction using aspects of the technology disclosed herein.

FIG. 2 depicts an interface for adding a file to an interaction.

FIG. 3 depicts an interface for adding a body to a message that has already been created.

FIG. 4 depicts an interface for launching a conference call.

FIG. 5 depicts an interface for presenting multiple interactions to a user.

FIGS. 6a-6c depict interfaces for managing and indicating relationships between uploaded files.

FIGS. 7a-7c depict interfaces for managing files in an interaction.

FIG. 8 depicts a high-level architecture for a system that supports interaction functionality.

FIGS. 9a-9d depict a set of database tables that support interaction functionality.

FIGS. 10a-10b depict interfaces that present information about Trains and Train elements to a user.

FIGS. 11a-11b depict interfaces that allow a user to activate and use a menu.

FIGS. 12a-12d depict interfaces useful for creating tasks.

FIGS. 13a-13b depict interfaces useful for creating and displaying tasks.

FIG. 14 depicts an interface that allows a user to transition to other interfaces or update the completion status of tasks.

FIGS. 15a-15b depict interfaces useful for organizing information into, and displaying the contents of, folders.

FIG. 16 depicts an interface useful for defining an event.

FIG. 17 depicts an interface useful for changing account settings.

FIG. 18 depicts an email that is automatically generated and sent by a system implemented using the inventors' technology.

FIG. 19 depicts tables which can be used in organizing content into folders.

### DETAILED DESCRIPTION

The inventors have conceived of novel technology which, for the purpose of illustration, is described below as being applied in a variety of contexts, including as a replacement for and/or supplement to email in interactions between parties who may be at multiple remote locations. While this description could be used to enable one of ordinary skill in the art to make and use the inventors' technology, it should be understood that the description in this document is not intended to imply limitations on how, or in what contexts, the inventors' technology could be used. Instead, this disclosure should be understood as being illustrative only, and not limiting on the protection accorded by the claims in this document or any related document.

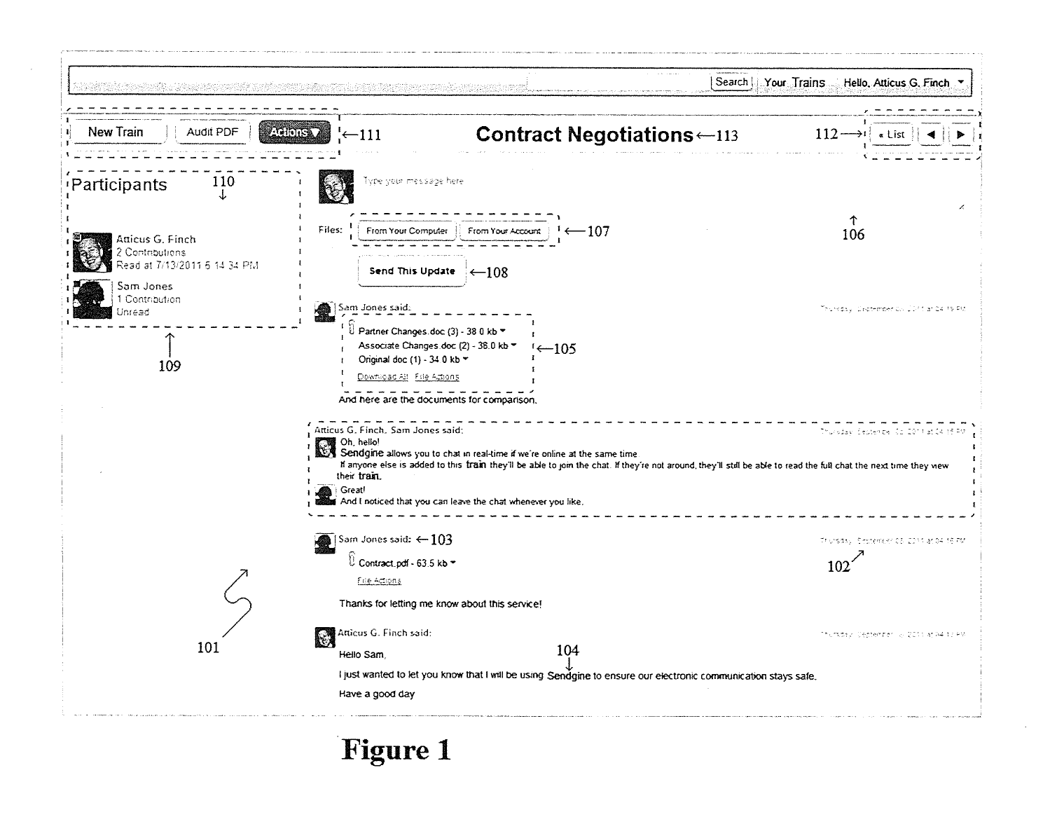

Turning now to the figures, FIG. 1 illustrates an interface which could be presented to an individual engaged in an interaction using aspects of the technology disclosed herein. In the interface of FIG. 1, there is presented a plurality of updates [101] organized under the title “Contract Negotiations” [113] in a structure representing a goal driven interaction between the individuals providing or viewing the updates (referred to herein using the term “Train” or the phrase “Train of Thought,” both of which are coined specifically for the purpose of describing the inventors' technology). The interface of FIG. 1 also includes information about the interaction and the updates that may be relevant for the user. For example, as shown in FIG. 1, each update can include a timestamp [102], showing when the update was sent and a sender identification [103] showing by whom the update was sent. These elements of the interface of FIG. 1 may also be implemented to do more than simply provide information. For example, a sender identification [103] could be implemented so that it is selectable by a user and, when selected, could collapse the Train so that only updates provided by the user associated with the selected sender identification [103] would be displayed. Depending on how the underlying system is implemented, this selection may apply only to the Train displayed when the selection is made, or may apply across all Trains in which the selected user is a participant.

Also, as shown in FIG. 1, an update can also include one or more Train elements (i.e., items of content making up the Train), including a message body [104], events, tasks/to-dos, and/or one or more files (represented in the interface of FIG. 1 by their file names [105]). Using an interface such as shown in FIG. 1, a new update can be added to a Train by entering a new message body into the message entry tool [106] presented at the top of the interface. Also, as shown in FIG. 1, it is possible that a new update in the Train can be created without requiring use of the message entry tool [106], such as by engaging other participants in the interaction in a real-time chat, which can be added to the Train as a single update having multiple message bodies, multiple senders, and a single timestamp showing when the chat took place (potentially augmented or replaced by additional timestamps showing when each of the statements in the chat actually took place).

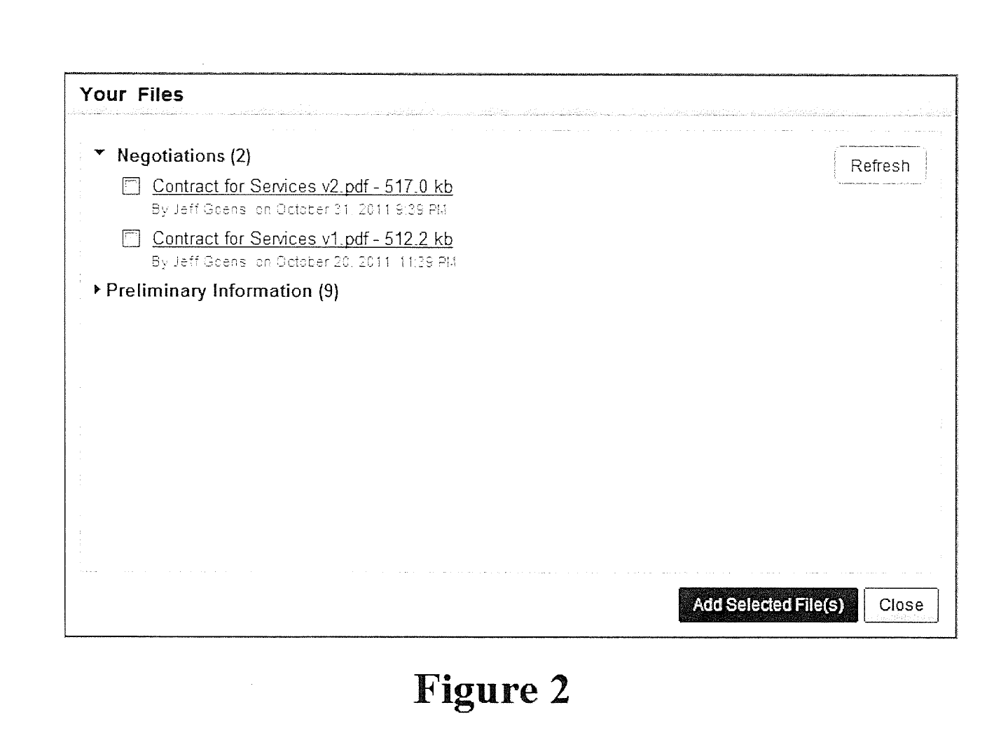

Another approach to creating a new update using the interface of FIG. 1 is to add a file to be uploaded without an accompanying message body. This could be performed using the file selection tools [107] shown below the message entry tool [106] in FIG. 1. These file selection tools could allow a user to add a file from his or her local computer using an interface, which is similar to the interfaces that are conventionally used to add attachments to email messages. Alternatively to providing interfaces similar to file attachment interfaces, or in addition to providing such interfaces, file selection tools could allow a user to add a file that the user had access to because it had previously been added to another Train in which that user is a participant. An interface that could be used for this purpose is shown in FIG. 2, which provides collapsible lists of files associated with Trains that the user can select to add to the current Train.

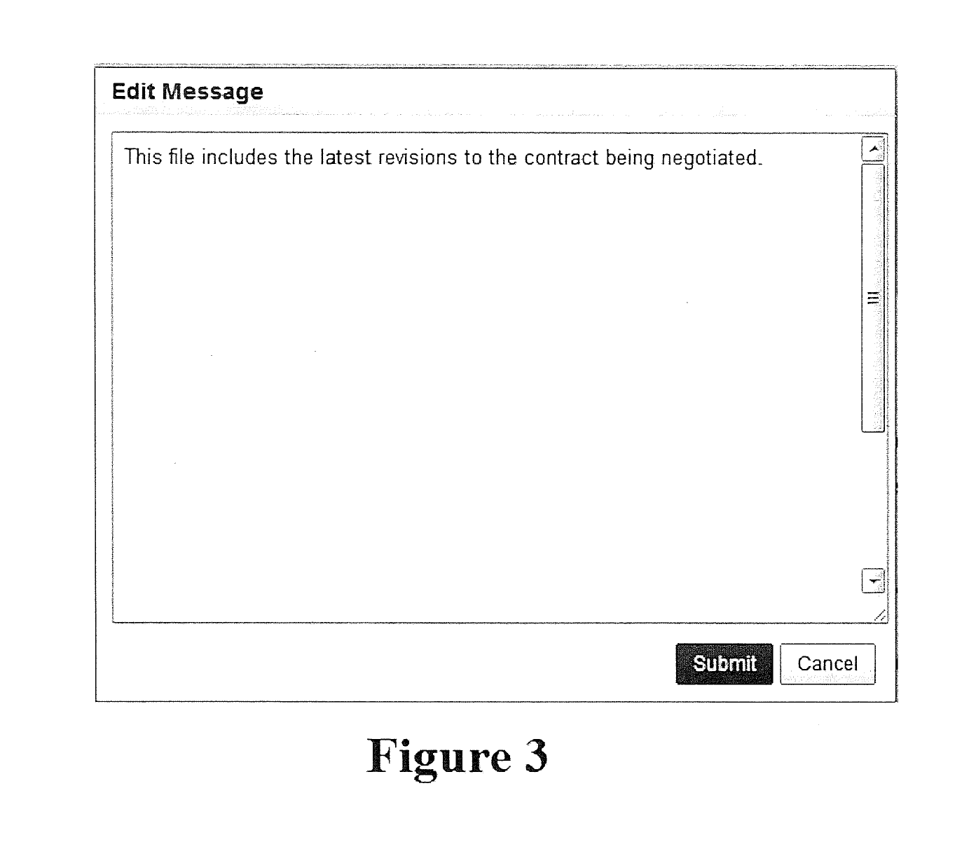

Of course, it should be understood that, while adding updates using message bodies and files were described separately, the interface of FIG. 1 could also be used to add an update that includes both a message body and one or more files by using both the message entry tool [106] and the file selection tools [107], then actuating the send update tool [108]. Similarly, in some implementations, an interface such as shown in FIG. 1 could be used to add message body text and files in a piecewise fashion. For example, a user could be allowed to create an update by adding a file then, so long as the update including the file had not been read by any of the other participants in the Train, he or she could be allowed to edit the update by adding a message body. An interface that could be used for such an after-the-fact addition of a message body is shown in FIG. 3. Some embodiments implement other types of file acquisition functionality, such as the ability to drag and drop files from the desktop of a local computer, or from other locations, which may be remote from the user. For example, a system implemented using the inventors' technology could include APIs that would allow integration with third-party cloud service providers, such that a user would be given the option of dragging files stored with the third-party service provider into a Train maintained on the system using the inventors' technology. Similarly, in some implementations a user could be allowed to generate previews of files, either stored by a system implemented using the inventors' technology, or on an integrated third-party system, so those files could be viewed without having to be downloaded to the user's local machine or, in the case of files stored on an integrated third-party system, copied to the system implemented using the inventors' technology (though, preferably, the system implemented using the inventors' technology will allow such downloading or copying to take place at the user's request).

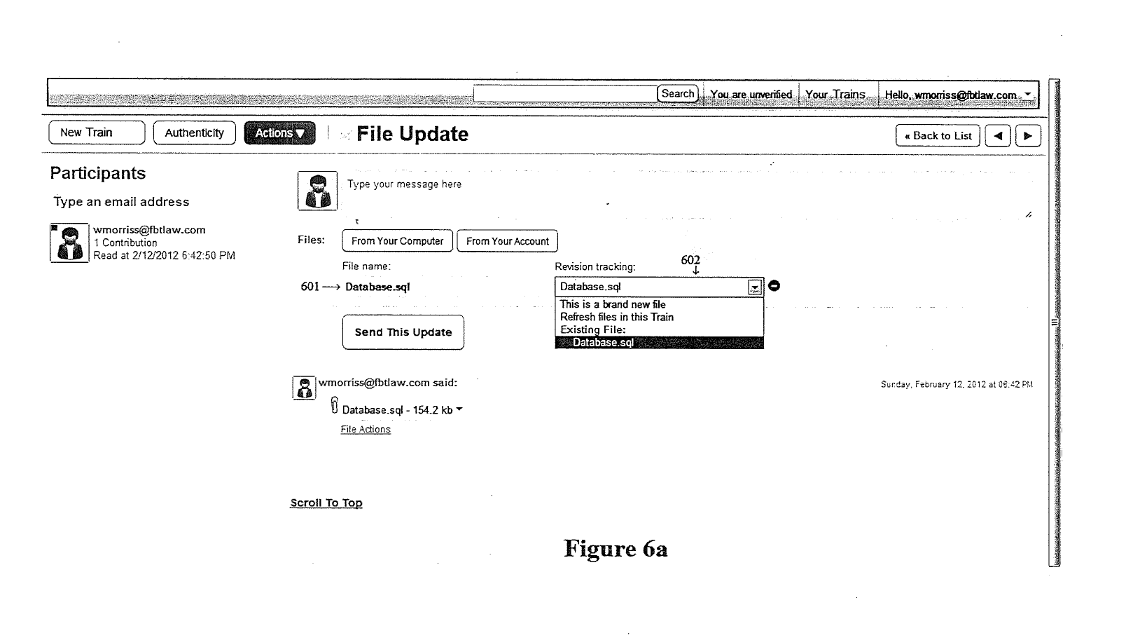

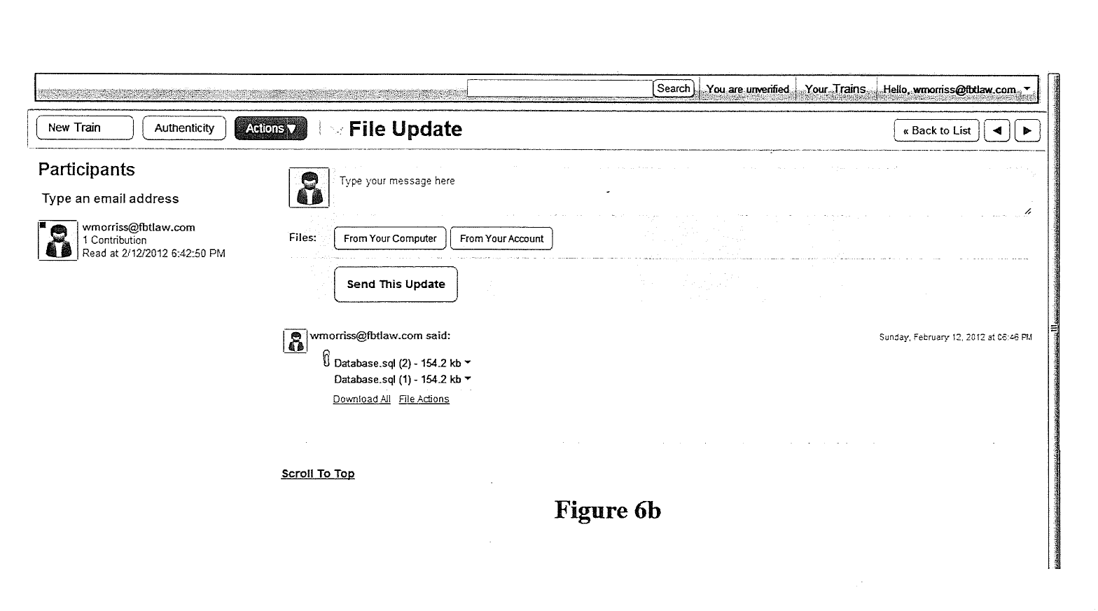

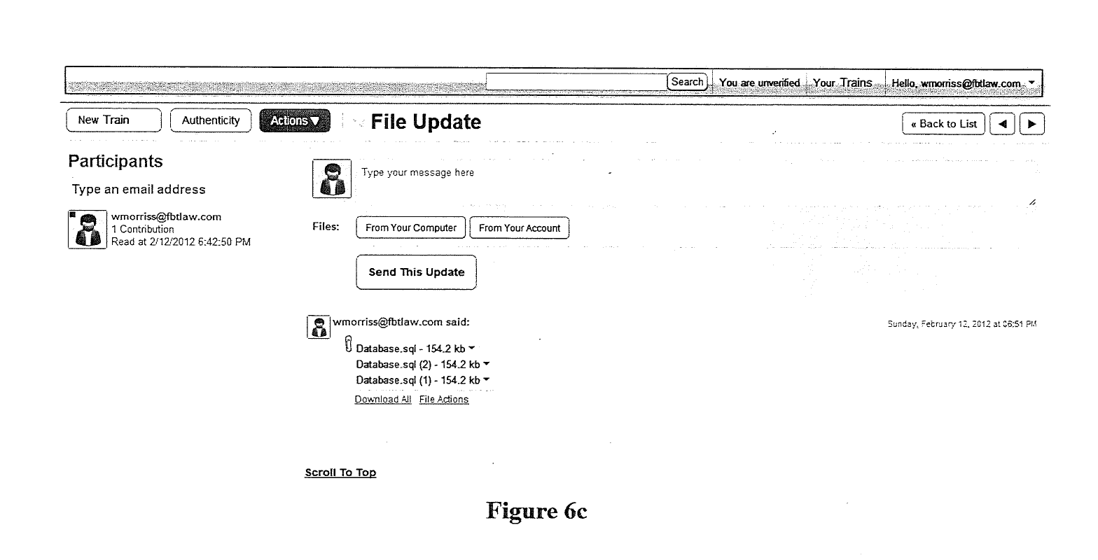

Beyond allowing a user to upload/ingest files as described above, a system presenting an interface such as shown in FIG. 1 could also be configured to include functionality that would allow users to manage and track relationships between files they upload/ingest. As an example of this, consider the exemplary interfaces of FIGS. 6a-6c. FIG. 6a depicts an interface that could be presented to a user who, as indicated in the file name field [601], wished to add a document called Database.sql to a Train. In that interface, a revision tracking tool [602] is presented, which can allow the user to indicate that the file he or she wishes to add is a new version of a file that has already been added to a Train. Such a revision tracking tool [602] could be implemented in a variety of manners. For example, in some cases, the revision tracking tool might generate a list of all files included in the Train and give the user the option of indicating that the file he or she wishes to upload is a revision of any one of those files. In other cases, the revision tracking tool [602] might only list files that had the same file name, or the same format, as the file the user wished to add to the Train. As yet another alternative, a revision tracking tool could, when actuated, present the user with an interface of the same type as shown in FIG. 2, including collapsible lists of files that had been added to Trains in which the user was a participant. Alternatively, it is also possible that the version tracking will take place automatically, with a system implemented using the inventors' technology performing tasks such as identifying if a file uploaded to a Train has the same filename as a file which was previously uploaded, and, if there is a previously uploaded file with the same file name, treating the file being uploaded as a new version (which treatment could, in some implementations, be overridden by the user). Further variations could also be implemented by, and will be immediately apparent to, those of ordinary skill in the art in light of this disclosure. Accordingly, the revision control tool [602] illustrated in FIG. 6a should be understood as being illustrative only, and should not be treated as limiting.

Regardless of its specific form, a revision control tool [602] such as shown in FIG. 6a can be implemented to allow a user to indicate relationships between documents, such as by indicating that the document being uploaded is a new version of a previously uploaded document. To illustrate, consider FIG. 6b, which is an exemplary interface that could be presented after the file “Database.sql,” is uploaded by a user who indicates that it is a new version of a file named “Database.sql” that was previously added to the Train. Consider also FIG. 6c, which shows an interface that could be presented after three files called “Database.sql” had been uploaded. As can be seen in that diagram, the interface presented to the user would indicate that the first two files uploaded were actually different versions of the same file, as shown by the automatically generated version numbers displayed to the right of the file names. By contrast, the third file, while having the same name as the first two, was identified as being a brand new file, which is reflected in the fact that it does not include a version number. In this manner, both the individual who uploads the file and other participants in the Train (if any) can identify the relationships between the different files associated with the interaction.

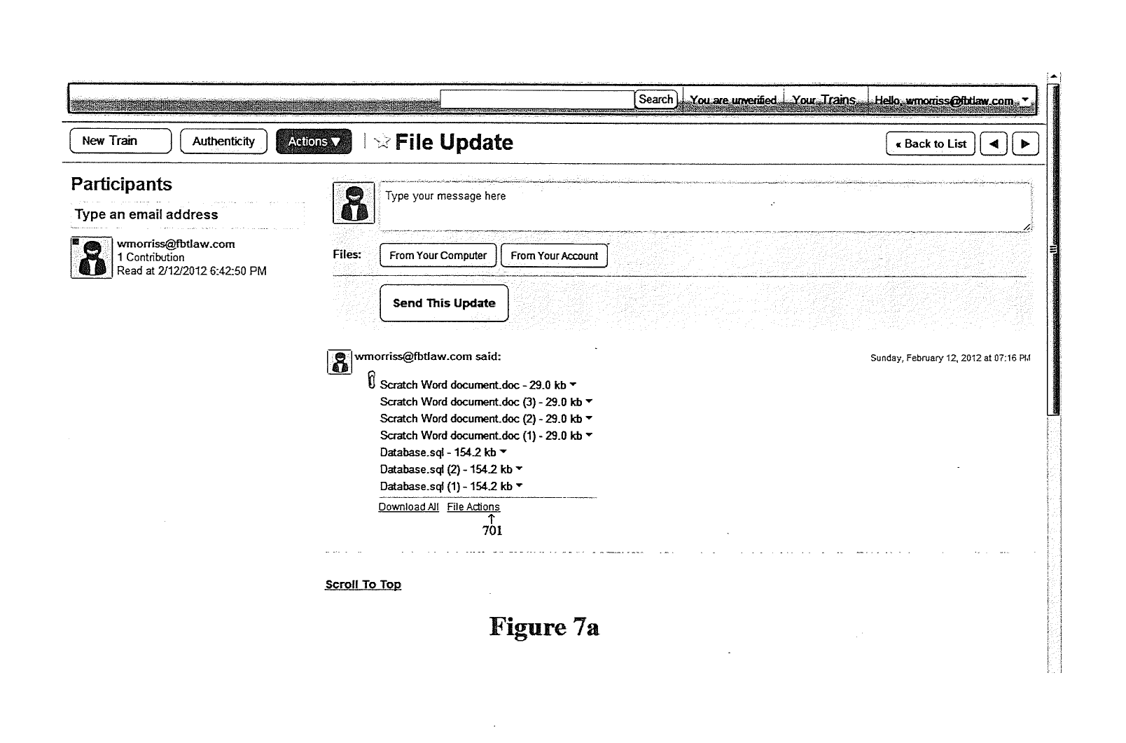

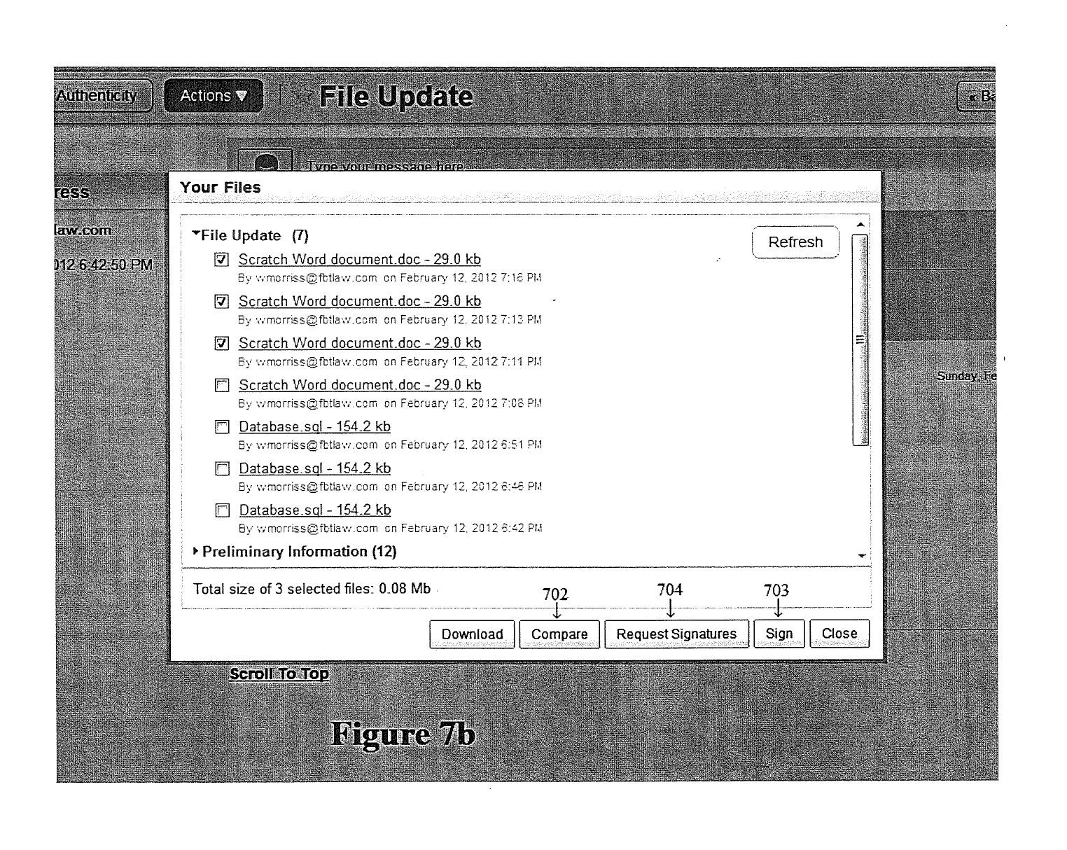

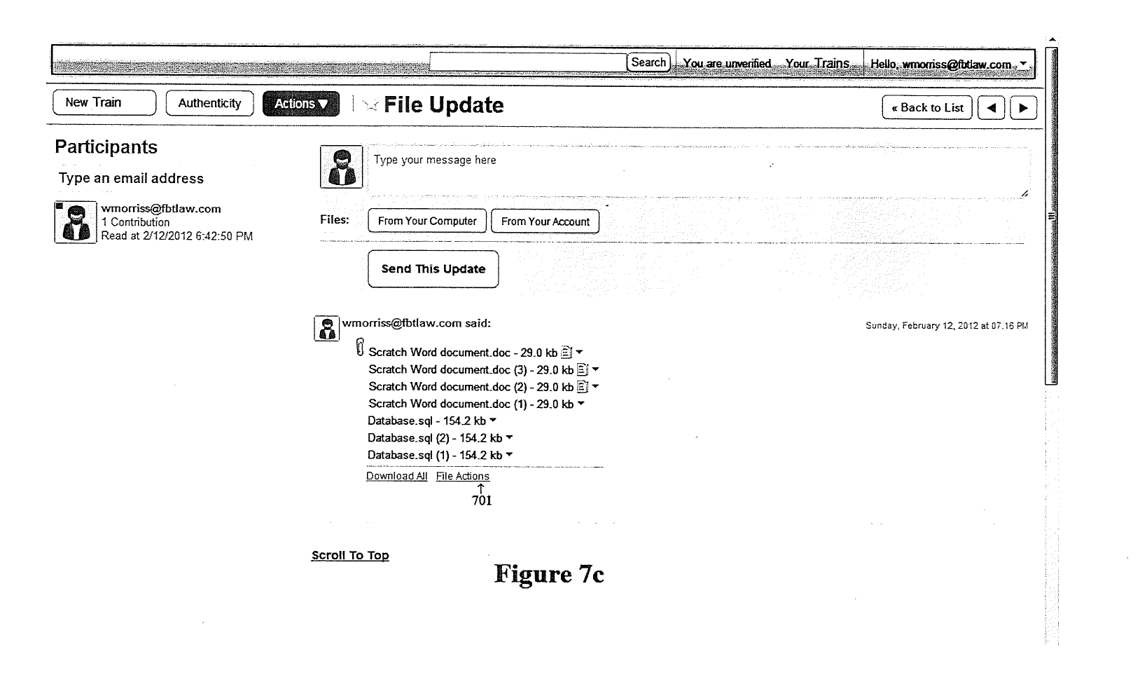

It should be understood that allowing a user to indicate a relationship between files at the time of file upload is not the only type of file management feature that can be provided by a system implemented based on this document. As an example of further functionality that might be provided, consider the interfaces shown in FIGS. 7a-7c. FIG. 7a depicts an interface similar to that shown in FIG. 6c, except that, in the interface of FIG. 7a, four more files have been uploaded, three of which are identified as different versions of the document “Scratch Word document.doc,” and one of which has the same file name, but has been identified as a brand new document. FIG. 7b depicts an interface that could be presented to a user who has activated the File Actions tool [701] in FIG. 7a and activated the check boxes before the first three documents referred to as “Scratch Word document.doc” in the resulting list. FIG. 7c depicts an interface that could be presented to the user after he or she has indicated his or her assent to the first three documents in the list using the sign button [703]. A similar graphic (i.e., an interface showing icons representing assent next to the file names of the assented to files) could be presented to the user if another participant in the Train had indicated his or her assent in response to a request made using the request signatures button [704]. Other file management tools are also possible, as will occur to those skilled in the art. For example, after using the comparison button [702], a user could be presented with an automatically generated redline showing how selected documents differ from one another. Similarly, an interface such as shown in FIG. 7b, that allows a user to perform actions on documents sent in multiple interactions (i.e., by choosing to expand the lists associated with different Trains, the user could be presented with a list of all files sent in that Train, and be allowed to perform actions on any of those files or files in other Trains entirely) could be accessed through interfaces other than the File Actions tool [701], such as the menu of actions [111] illustrated in FIG. 1.

Other tools that can be used to administer Trains beyond the file management tools described above are also possible. For example, on the left side of FIG. 1 there is a participant list [109]. This participant list shows the individuals who are participating in a Train, how many updates those participants have provided, and when those updates were read. Additionally, the interface of FIG. 1 provides a mechanism for adding new participants in the form of a participant entry form [110]. In a preferred embodiment, this participant entry form [110] will allow selected users (i.e., the creator of the Train and others depending on the settings selected by that creator) to identify a new individual who should participate in the Train by entering that individual's email address into the participant entry form [110]. This will result in an email message being sent to the entered address with a link that, when clicked, will cause the recipient's web browser to access the Train through an interface such as shown in FIG. 1. In the event that the recipient is already a user of the service hosting the Train, he or she would then be able to view all content in the Train (potentially after authenticating himself or herself as a user, such as by entering a password), and participate in the Train as if he or she had been included from the Train's inception, regardless of when he or she was actually invited to join. Alternatively, in the event that the recipient was not already a user of the service hosting the Train, he or she could be allowed to view all or a controlled portion of the Train (e.g., a portion of the Train for which enhanced security had not been activated), but might be prevented from modifying the Train until he or she had agreed to the terms and conditions of the service by which the Train was hosted.

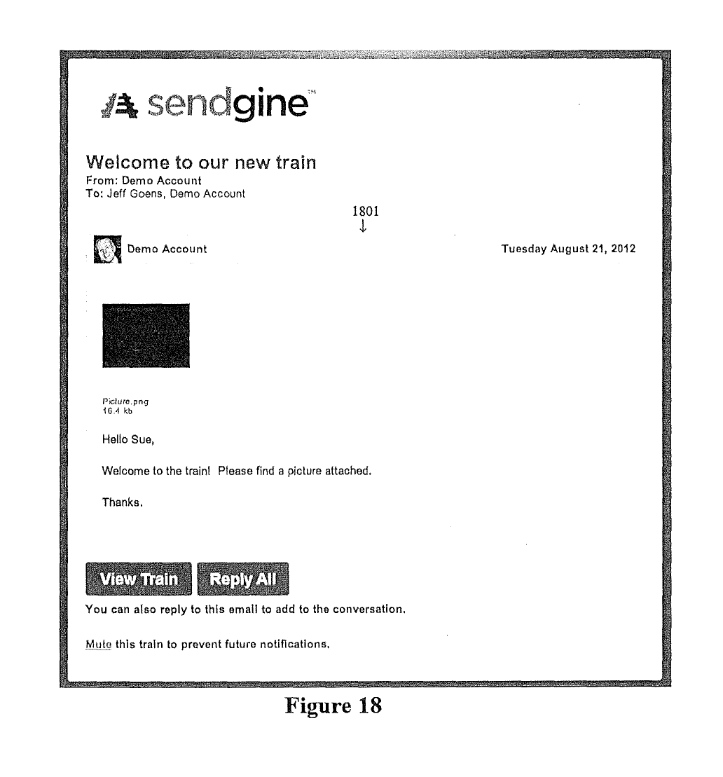

Other information or tools could also be included in an email message sent to invite a new participant to a Train. For example, as shown in FIG. 18, the email message could include the content [1801] of a Train element added at the same time the new participant was specified. The email message could also be sent in a manner that would allow the user to modify the Train he or she had been invited to simply by replying to the email, without having to view the Train. For example, the email could be sent with “reply-to” information including an email address maintained by the service hosting the Train, which email address could be uniquely associated by the service (e.g., by including an identifier for the Train in the email address) with the Train the recipient had been invited to join. In such a case, the recipient could reply to the email as if it were any other email, and the result would be that the user's reply would be added to the Train where it could be viewed by the Train's participants.

Of course, alternative approaches to adding new participants, such as allowing a user to add new participants using friend lists, allowing contacts to be imported from a list of contacts maintained by integrated third-party services, tools for searching an existing membership base, and other well known approaches will be immediately apparent to those of ordinary skill in the art in light of this disclosure. Accordingly, the discussion of the participant entry form [110] and the email of FIG. 18 set forth above should be understood as being illustrative only, and should not be treated as limiting.

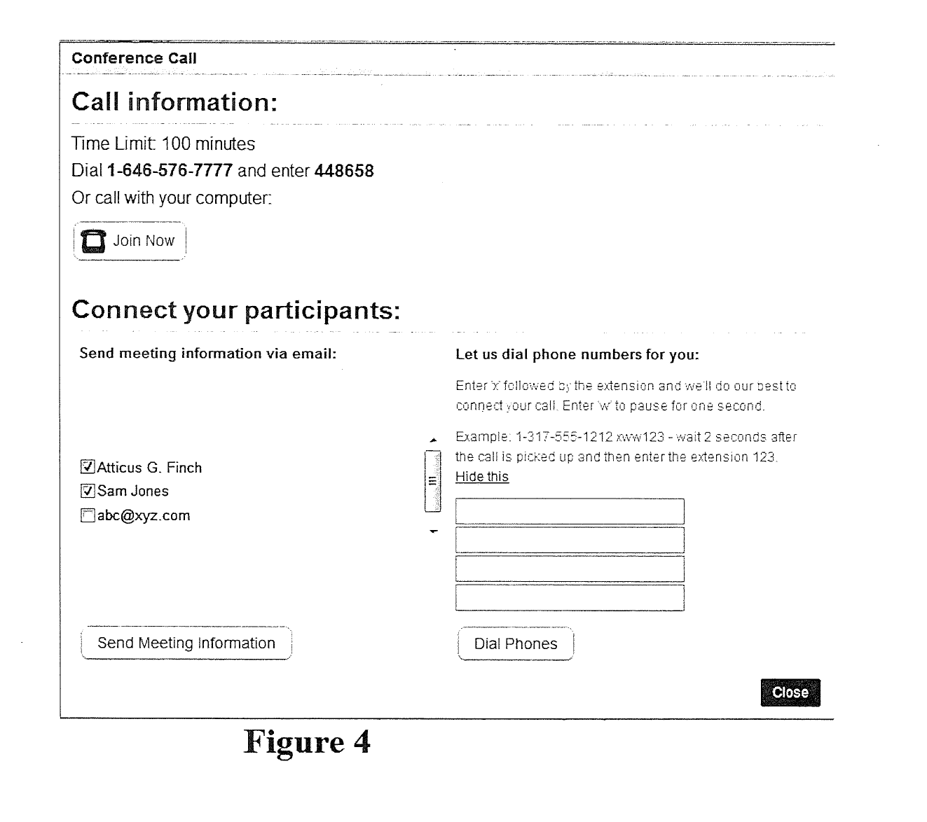

Additional or alternative tools can also be presented to a user to help him or her manage Trains, train elements, and/or content within train elements. For example, as shown in FIG. 1, the user can also be presented with a menu of actions [111]. These actions can be any of a variety of actions, including:
Create New Train Creates a new Train for which the user is the originator and has all associated permissions.
Generate Authenticity Report Create a downloadable report/journal (e.g., a PDF file) that lists updates that took place in the Train up to the point of the creation of the authenticity report (e.g., when updates are added, when they are read, etc.). The listing of updates can include all updates in the Train, or could include only updates or types of updates selected by the user generating the report (e.g., the user could be provided with an interface which would allow him or her to select particular updates to include, and/or to indicate that some types of updates (e.g., those with messages, those with files, those with tasks, etc) should or should not be included). Preferably, the report will include a unique identifier that will be stored in a database along with a signature that can be determined from the report (e.g., MD5 hash or a QR code functioning as a unique hyperlink to a website where the document can be uploaded to determine whether it had been tampered with). In embodiments where they are present, this type of signature and identifier can be used to validate the report, such as by scanning a QR code from the report and comparing the hash of that code with the hash stored for the report's unique identifier in the database, or by uploading a copy of the report through the website, and comparing the signature for the uploaded document (e.g., an MD5 hash) with a signature stored in a database when the report was originally created.
Delete Deletes the current Train. This action would render all messages in the Train inaccessible to the participant who selects the “Delete” action and, in the instance where the participant who selects the “Delete” action is the only participant in the Train, could result in the Train itself being deleted all together (e.g., the memory used to store the Train being deallocated). Also, in some embodiments, a “Delete” action may render the Train inaccessible to all participants, though this will preferably only be an option for the individual who created the Train, and will only be available if the other participants have been informed that the Train can be deleted at any time.
Conference Call Allows the user to automatically initiate a conference call with selected participants in the Train. If selected, this option can result in the user being presented with an interface such as shown in FIG. 4 for creating the call.
Adding an Item to the Train Allows the user to add a form (e.g., a questionnaire he or she has created) or to add a password that will be applied to a file being uploaded in addition to whatever security is normally provided by the system supporting the Train (e.g., “double locking” the file).
Finalize Prevent any additional changes from being made to the Train by any participants and create a record of the Train. Preferably, this option will be available only to the individual who originally created the Train.
Lock Participants Prevent any additional participants from being added to the Train. Preferably, this option will be available only to the individual who originally created the Train.
Self-destruct Set a timer (e.g., five days, 30 days, 90 days, immediate) which, upon expiration, will cause the Train to be deleted (i.e., rendered inaccessible to all participants, as if each participant in the Train had deleted it). Preferably, this option will be available only to the individual who originally created the Train, though in some implementations, this may be made accessible to participants other than the initiator of the Train, or participants other than the initiator of the Train may be provided with an interface which can be used to prompt the initiator to set the Train to self-destruct.
Add Star Add a star or other identifier to a Train or Train element, which star or identifier could be made visible to all participants in the Train, thereby alerting them to the importance of the identified Train or Train element.
Add Highlight Add highlighting (in some embodiments, highlighting of a particular color) to the display of certain text or other content within a train item. This may be certain text that the user selects before initiating the action.

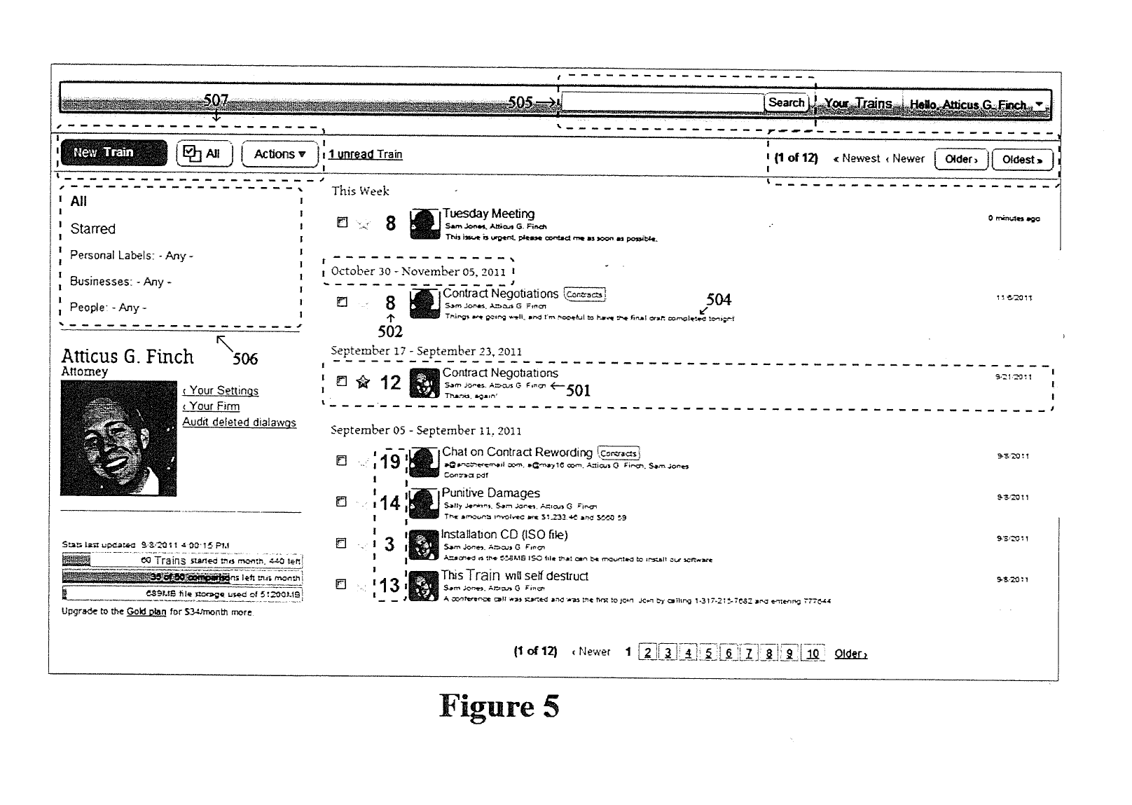

Other Train management tools could also be included, either in an interface as shown in FIG. 1, or in other interfaces that could be presented to a user. For example, in some implementations, when a user actuates a list control [112], he or she could be presented with an interface such as shown in FIG. 5. In that interface, the Trains in which the user is participating are grouped according to the last week in which they were updated. Additionally, as shown in FIG. 5, to assist the user in managing his or her participation in multiple Trains, relevant information about the Trains can be provided, such as the participants in the Trains [501], the number of updates in the Trains [502], and the message body and/or names of files provided in the last update [504]. The user can also be provided with tools that allow for full text searching of his or her Trains [505], tools that allow the user to filter Trains [506], and tools that can perform actions on Trains [507], such as downloading Trains, creating authenticity reports for Trains, or creating or deleting Trains.

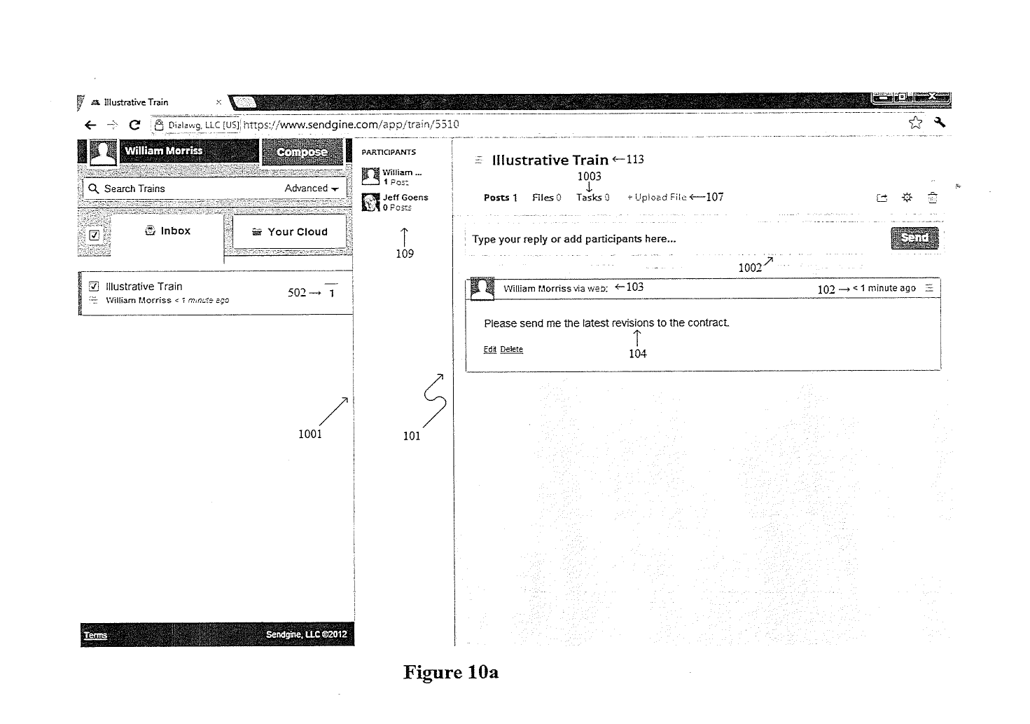

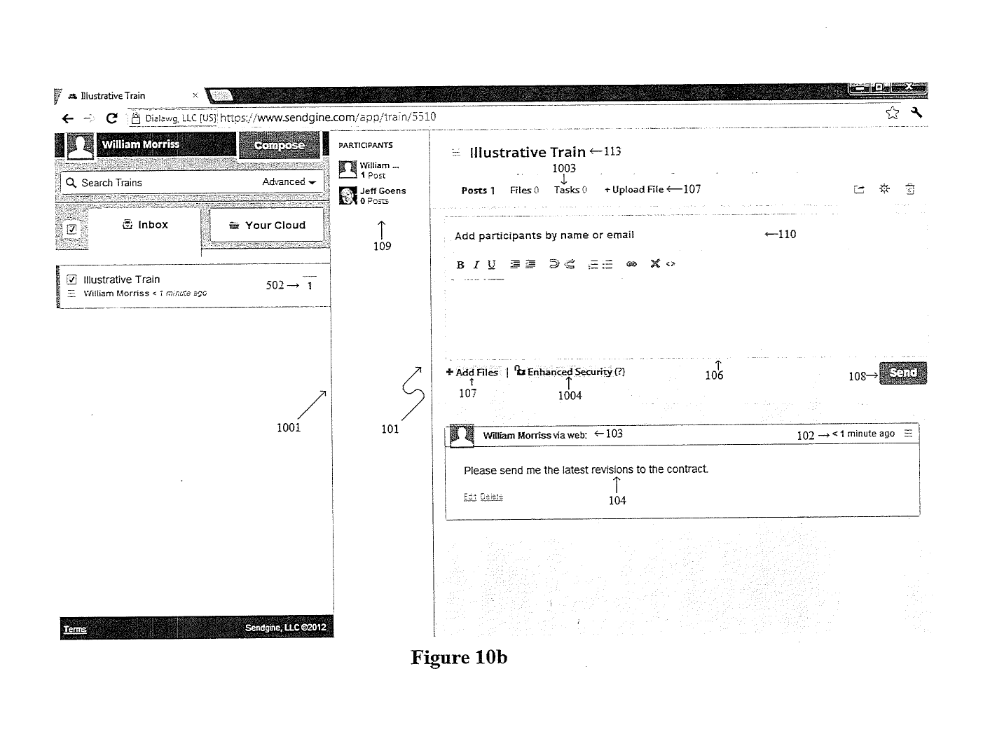

It should be understood that the interfaces depicted and discussed above are intended to be illustrative only, and that the various features illustrated in the discussion above could be assembled in different combinations in other implementations of the inventors' technology. As an example of this, consider the interface of FIG. 10a, which illustrates another way that information about Trains and their constituents could be presented to a user. As shown by the reference numbers that are common to both FIG. 10a and to figures discussed previously (e.g., FIGS. 1, 5), one way in which the interface of FIG. 10a differs from the interfaces discussed above is that the interface of FIG. 10a includes a combination of elements which is not found in any single one of the interfaces discussed above. For example, the interface of FIG. 10a includes both a file selection tool [107] such as illustrated in FIG. 1, and a list of Trains not unlike that from FIG. 5 (though only one Train is included in the list of FIG. 10a) with identifications [502] of the numbers of updates for each Train in the list. Other combinations of elements from multiple interfaces could also be made without undue experimentation in light of this disclosure. Accordingly, the discussions of the specific combinations of elements that could be presented in particular screens should be understood as being illustrative only, and not limiting.

Variations beyond simply combining different elements from multiple interfaces are also possible. For example, FIG. 10a includes additional interface elements which allow information to be presented in a different manner than discussed above. These additional interface elements include a middle rail [1001], which is an aspect of the interface of FIG. 10a that allows information about the Train (in the case of the exemplary interface of FIG. 10, the Train's participants, and how many posts they have contributed to the Train) to be presented in an easily accessible form. The additional interface elements also include an addition tool [1002], which is an aspect of the interface of FIG. 10a that allows the interface of FIG. 10a to save screen space by combining a participant addition tool [110], message entry tool [106], and send update tool [108] when those individual tools are not being used. The effect of this addition tool [1002] can be seen in FIG. 10b, which could be presented to a user who activates the addition tool [1002].

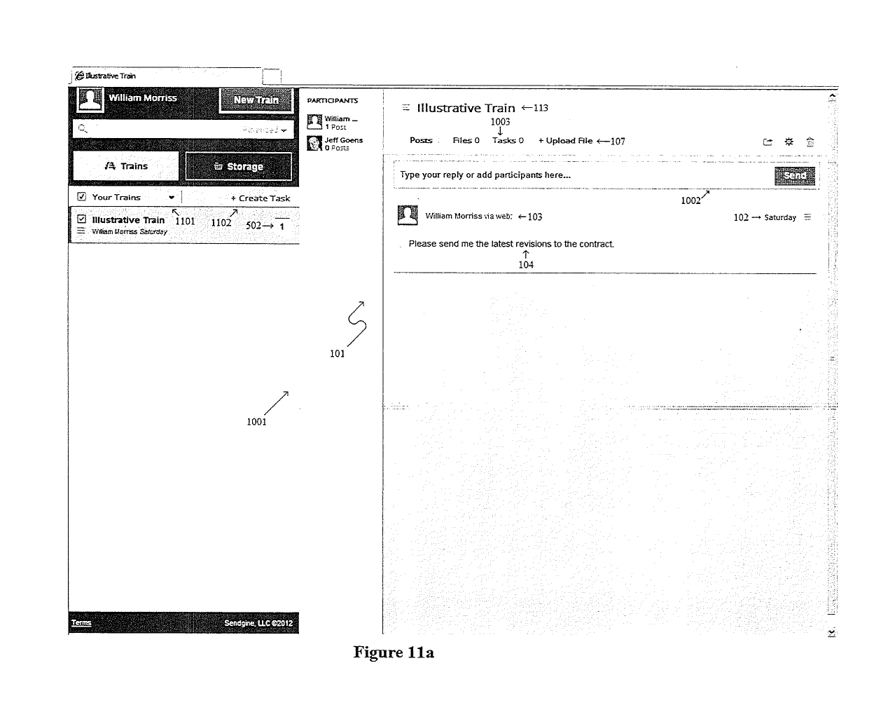

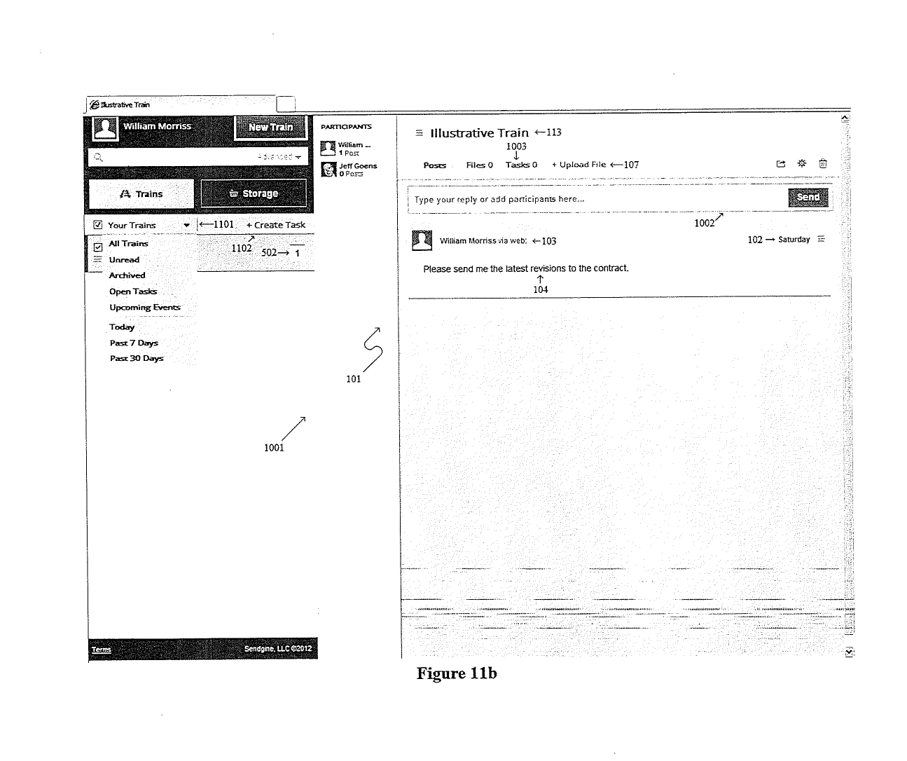

Other types of new interface elements can also be included in interfaces implemented according to this disclosure. As an example, consider the “Your Trains” menu [1101] depicted in FIG. 11a. As shown in FIG. 11b, when a user activates the “Your Trains” menu [1101], he or she can be presented with a drop down menu providing a number of pre-configured search filters that can be applied to provide a customized list of Trains. In the interface of FIG. 11b, those filters are to show all of the user's Trains, to show Trains that include unread updates, to show Trains that have been archived (i.e., removed from the user's search and visibility unless the user specifically asks to include archived Trains, or an update to the Train, which in some implementations the effect of unarchiving the Train, is made), to show Trains that have open tasks, to show Trains that have upcoming events, and to show Trains that were modified during various time periods (e.g., same day, within the past seven days, and within the past 30 days). Of course, it should be understood that the pre-configured search filters of FIG. 11b are intended to be illustrative only, and should not be treated as limiting. Other filters or types of filters could also be used. For example, in some cases, a “Your Trains” menu [1101] would provide the user with pre-configured filters based on participants who have recently made comments (e.g., the names of each individual who was a participant in any Train in which the user is a participant could be displayed, and selecting them would present a list of all Trains in which the user was participating where those users had provided an update). Similarly, in some cases, a user could be allowed to customize a “Your Trains” menu [1101] to include specific search filters desired by the user, such as filters operating as a function of one or more properties of the Trains, the elements of the Trains, and/or the content of the Train elements described herein. As a result, the protection accorded by this document or any related document should not be limited to the specific options included in the “Your Trains” menu [1101] of FIGS. 11a-11b (or even to including a “Your Trains” menu [1101] at all).

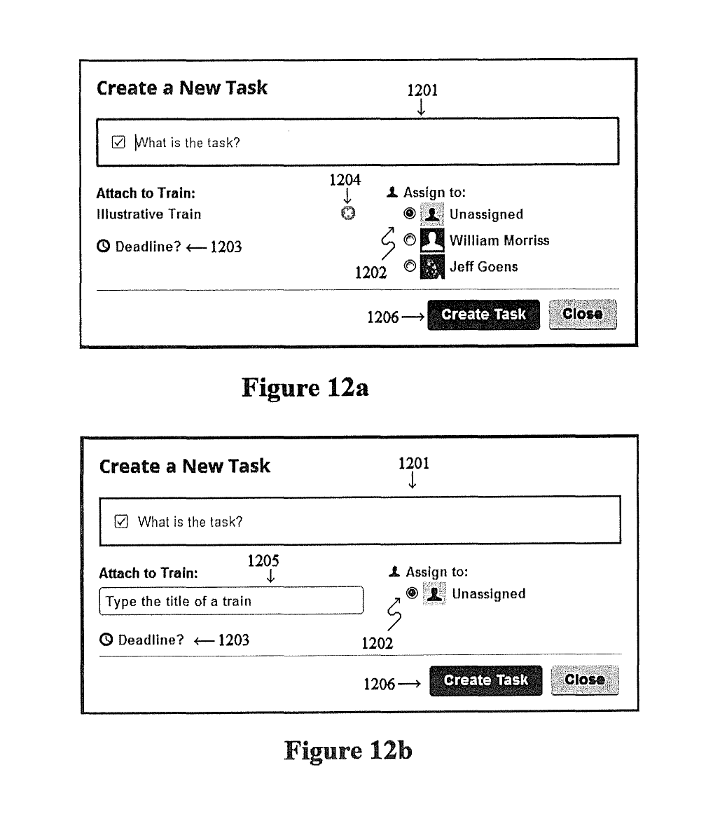

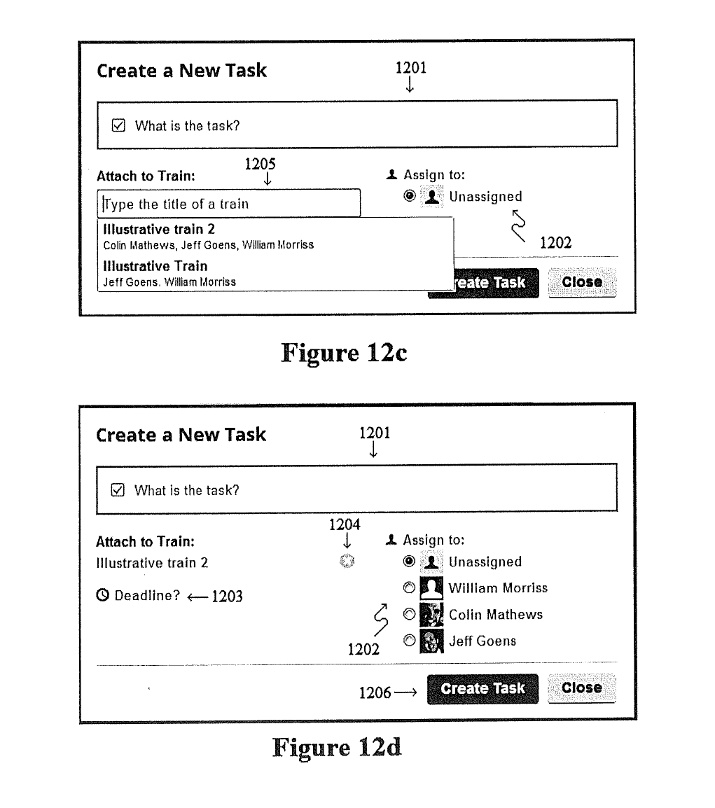

In addition to (or as an alternative to) potentially including interfaces with different interface elements, it is also possible that some implementation of the inventors' technology could support different functionality than discussed in the context of FIGS. 1-7c. As an example of this, consider the task creation tool [1102] depicted in FIGS. 11a-11b. In some implementations, when that tool [1102] is activated, the user could be presented with an interface such as shown in FIG. 12a. In the interface of FIG. 12a, the user is provided with a description entry tool [1201], an assignment target selector [1202], and a deadline selector [1203], which he or she can use to, respectively, add a description for the task, identify a participant in the Train to that the task is attached to whom the task should be assigned, and identify a deadline for the task. Additionally, the interface of FIG. 12a also shows a Train deselector [1204]. This Train deselector [1204] can be presented to allow a user defining a task to modify the Train the task will be attached to, for example, by using a Train specification tool [1205] as shown in FIGS. 12b-12c, with FIG. 12c depicting a menu that could be presented to a user upon selecting the Train specification tool [1205] to allow the user to select from his or her Trains, rather than requiring the user to type the Train's name to specify it.

Note that, in the interfaces shown in FIGS. 12b-12c, assignment target selector [1202] differs from that shown in FIG. 12a in that it does not include Train participants to whom the task can be assigned. This is a reflection of the fact that, in the interfaces of FIGS. 12b-12c, no Train for the task is specified, with the result that there are no participants to whom the task can be assigned. FIG. 12d shows a result that can take place when a Train is specified using a Train specification tool [1205] in some implementations—i.e., the assignment target selector [1202] is automatically populated with the participants of the Train that the user has selected. A similar process could be followed for the selection of a deadline using the deadline selector [1203], with the user being presented with an additional interface, a menu, a radio button selector, a text box, or other type of tool upon activation of the deadline selector [1203], and the task definition interface being automatically updated with the deadline once it has been selected by the user. Once the parameters of the task (e.g., the individual it is assigned to, the deadline, and the attached Train discussed above) had been specified, the individual creating the task could activate the creation button [1206], which would result in the task being added to the specified Train.

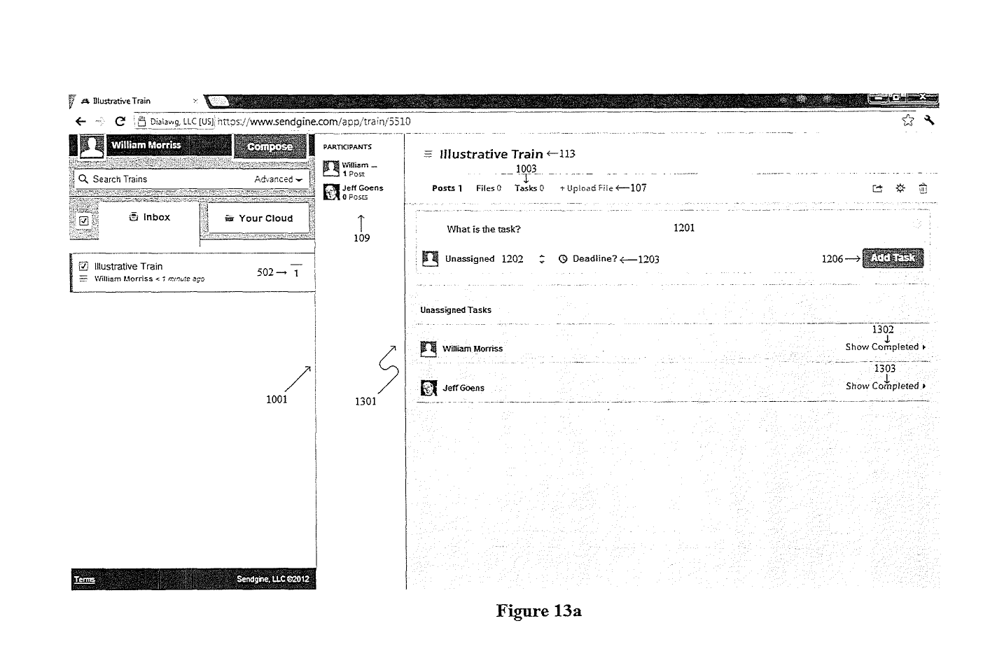

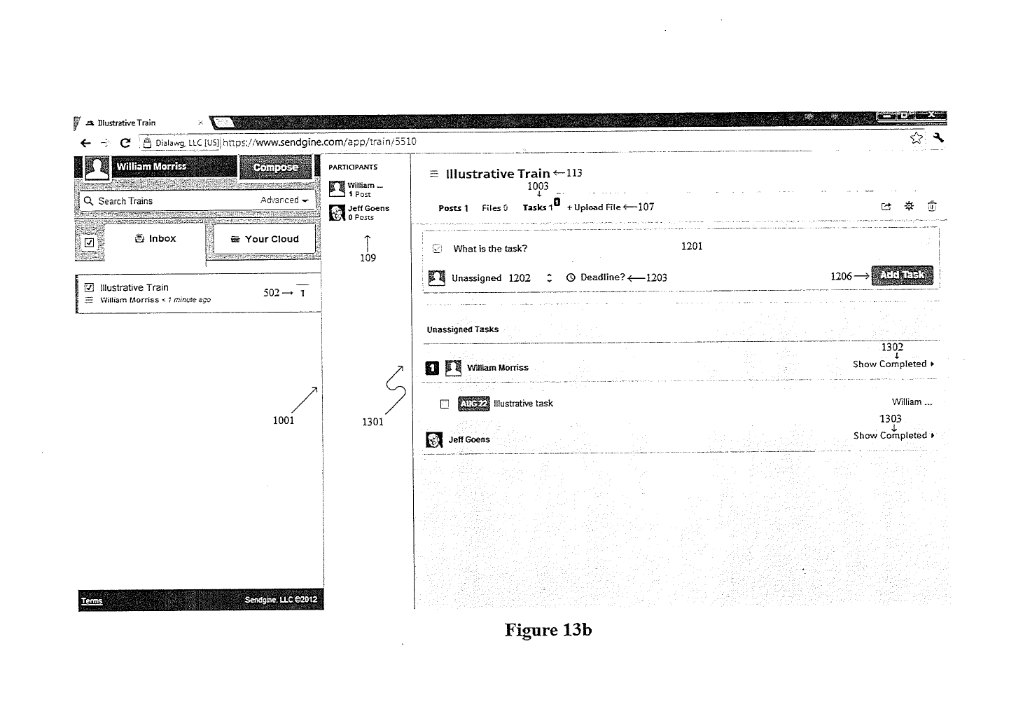

It should be understood that the interfaces of FIGS. 12a-12d are not the only ways that tasks could be created using the inventors' technology. For example, in an interface such as shown in FIGS. 10a-11b, a user could activate an attached task creation tool [1003], and be presented with an interface such as shown in FIG. 13a. In that interface, the user is presented with, in addition to task creation tools such as discussed in the context of FIGS. 12a-12d, a list of tasks [1301] that will, by default, show the uncompleted tasks attached to the current Train and assigned to the various participants and that can, at the user's option (as indicated using the completed task display selectors [1302][1303]) show the completed task for the individual participants as well. An example of how the list of tasks [1301] could be updated when an illustrative task with a deadline of August 22 is created is shown in FIG. 13b. Note that, in the interface of FIG. 13b, the task creation tool [1003] differs from the task creation tool [1003] shown in the other figures in that it indicates the number of tasks that have been created for the current Train and in that it indicates the number of unfinished tasks that have been assigned to the user to whom the interface is being presented.

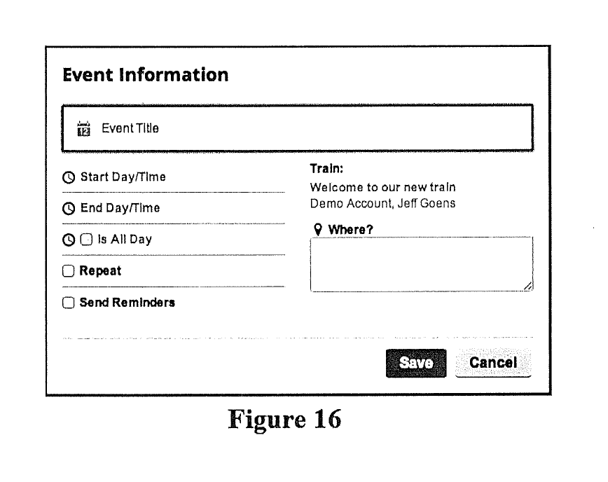

It should also be understood that providing users with the ability to create tasks is not the only way that the inventors' technology can be used to add time-based Train elements to a Train. To illustrate another type of time based element that could be added to a Train in addition to (or, in some implementations, as an alternative to) tasks, consider the interface of FIG. 16, which could be presented to a user who wished to add an event to a Train. This interface, which could be accessed by activating, in an interface such as shown in FIG. 10b, an event creation control (e.g., a link, a button, a selectable menu item, not shown in FIG. 10b), allows a user to set the title of the event, its start and end time, whether it's an all-day event, and whether or not it repeats. The user can also elect to send reminders for the event, and specify where it will be located. In some implementations, an event creation interface may also allow the user to specify individuals who are participating in the Train who are required to attend the event, or who may optionally attend the event, but are not required to do so. However, as indicated by the absence of a control imparting such functionality in FIG. 16, a user may not be provided with the option of specifying attendees for the event. In such a case, the user could use a message entry tool [106] to create a message to be associated with the event that would explain the purpose of the event, and who, from the participants in the Train, should attend.

In implementations where users are provided with the ability to create time-based Train elements, there may also be implemented further interfaces that assist users in the review and management of those elements. For example, in some implementations, users may have the ability to view Trains from a temporal perspective through an interface taking the form of a calendar. This calendar could be automatically populated with the tasks and events that had been added to the Train, and may display information regarding those tasks and events, such as their completion status (e.g., if the user to whom the task is assigned indicated its completion (or completion of an associated subtask), a check mark could be presented next to the task (or subtask) indicating its completion; alternatively, a completed task might simply be moved off of a list of open tasks, rather than being affirmatively displayed as a completed task; etc.), dependencies (e.g., in implementations where a user is allowed to define a time for a task or event in terms of the completion of another task or occurrence of another event, the tasks or events could be connected on the calendar to reflect this relationship), or targets (e.g., icons representing tasks or events on a calendar could be color-coded or otherwise identified to indicate the Train participants to whom the tasks are assigned or who are required to participate in the event). Additionally, in some implementations, in addition to being able to view individual calendars for individual Trains, a user may be able to view a combined calendar featuring time-based elements for all Trains in which he or she is a participant (e.g., using a calendar link in a home interface). Similar features, such as allowing a user to see calendars that include all changes to a Train (e.g., when a new participant is added, an old participant is removed, or a new Train element is added), or allowing users to filter the types of information that will be displayed in a calendar, could also be included in systems implemented using the inventors' technology.

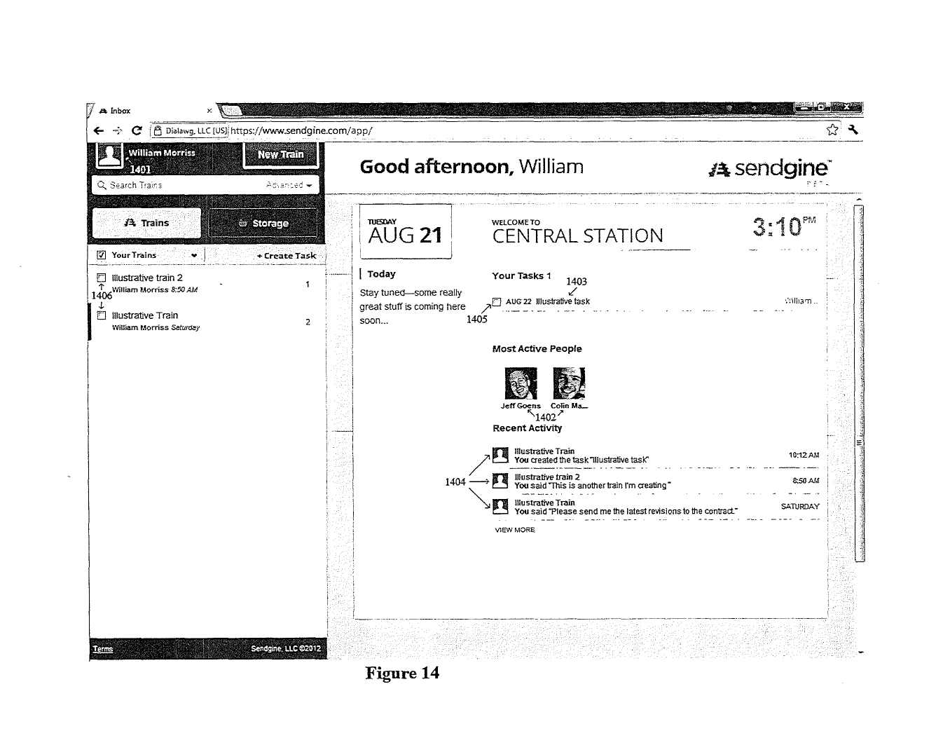

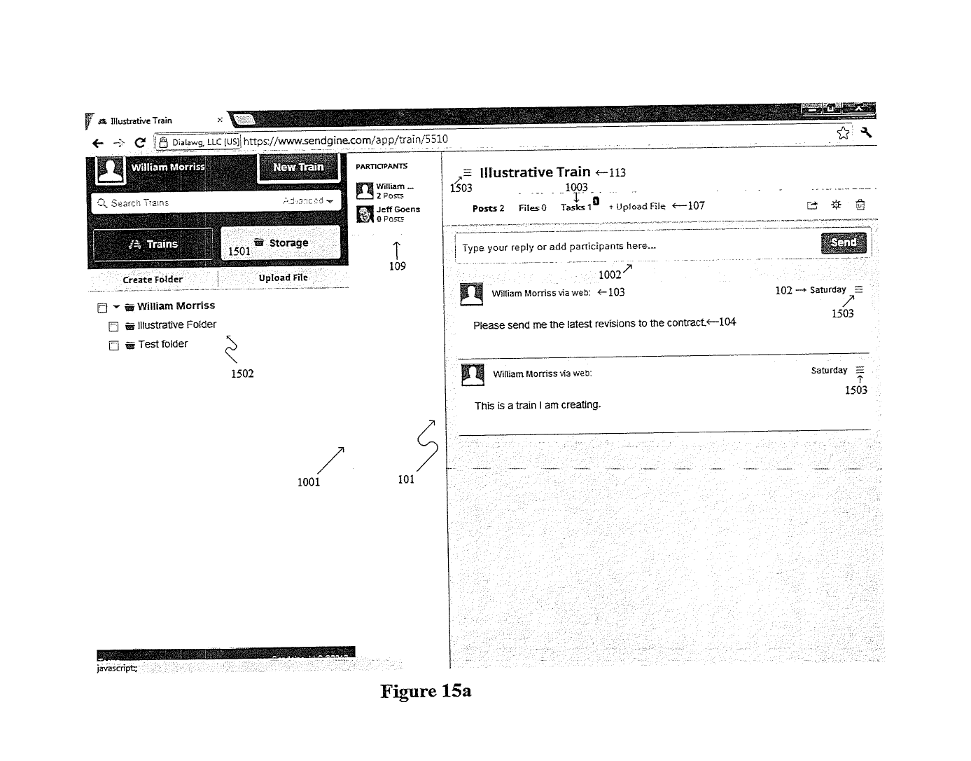

Another example of a type of alternative interface that could be presented in some systems implemented based on the inventors' technology is presented in FIG. 14. The interface of FIG. 14 could be presented to a user as a default interface when he or she first logs into a system implemented using the inventors' technology, or subsequently in the event the user activates a central station control [1401]. In that interface, the user can be presented with a variety of types of potentially useful information. For example, in the interface of FIG. 14, the user is presented with identifications [1402] of other users who are participating in Trains with the user who had provided the greatest numbers of updates (either recently or in absolute terms) to those Trains. Such identifications [1402] could simply identify the users, as shown, or could also be susceptible of activation and, when activated, could provide additional information such as the tasks assigned to the user, the tasks the user assigned to the individual viewing the interface of FIG. 14, Trains the user and the individual the viewing the interface of FIG. 14 are both participating in, and/or other information as may be desirable given the circumstances of a particular implementation.

The interface of FIG. 14 also includes identifications of tasks [1403] (or, in the case where there is only one task, the task) that had been assigned to the user, and identifications [1404] of the most recent updates to the Trains in which the user is participating. Like the identifications [1402] of other users participating in Trains with the user to whom the interface of FIG. 14 is presented, these other identifications may also be susceptible of activation by a user. For example, selecting an identification of a most recent update [1404] may result in the user being automatically presented with the Train that included that update, with the interface presenting the Train centered on the updated selected by the user. Similarly, selecting an identification of a task [1403] may automatically result in the user being presented with a calendar showing the user's tasks, with the interface presenting the calendar centered on the task whose identification was selected by the user. An interface such as shown in FIG. 14 may also be implemented to allow a user to perform tasks beyond simply transitioning to other interfaces. For example, in the interface of FIG. 14, a user could activate a task completion tool [1405] (shown as a checkbox in FIG. 14) to update the completion status of a task (e.g., checking the checkbox associated with a task in FIG. 14 to indicate that that task is finished).

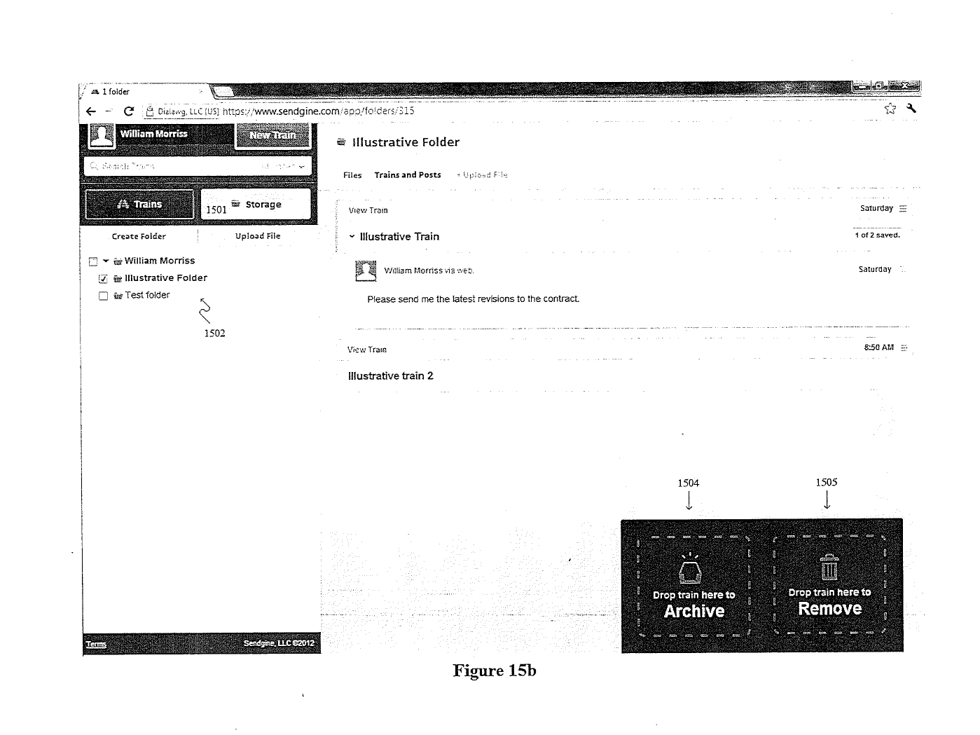

Another type of feature that can be included in some implementations, and that could potentially be accessible from interfaces such as FIG. 14, is the ability for users to use a structure of hierarchical folders to organize their Trains and, potentially in some implementations, the various elements that had been added to those Trains. To illustrate how this type of feature might be implemented, consider the interface of FIG. 15a. In that interface, which could be presented to a user after he or she has activated a storage control [1501], there is a list of folders [1502] that had been created previously. In order to use those folders, the user could click on a movement handle [1503] (depicted as three horizontal bars in the interface of FIG. 15a) and use it to drag the associated Train element or Train into the desired folder. Alternatively (or, in some implementations, in addition to the movement of individual Trains or Train elements using movement handles), a user could also be allowed to move multiple Trains or Train elements at once. This could be achieved, for example, by selecting the Trains or Train elements to be moved by checking selection boxes for the Trains or Train elements (depicted as Train selection boxes [1406] in FIG. 14, and not depicted for Train elements), then dragging one of the selected Trains or Train elements to indicate where all of the selected Train or Train elements should be placed.

An interface that could be presented to a user after he or she had dragged one of the Train elements from the Train titled “Illustrative Train” and the Train titled “Illustrative Train 2” to the folder titled “Illustrative Folder” is depicted in FIG. 15b. In that interface, there are two activated screen areas [1504] [1505] associated with the actions of archiving or deleting a Train dragged onto those screen areas. While, as indicated in FIG. 15b, such archiving and deleting screen areas [1504][1505] could be automatically displayed to a user who views the Trains and Train elements located in a folder, it is also possible that they could only be displayed once a Train which could potentially be archived or deleted is selected or dragged. For example, a system implemented using the inventors' technology could define interface which includes a movement handle [1503] as a web page including Javascript code which would detect the selection of the movement handle [1503] (e.g., a mouseover event over the handle [1503], a lbuttondown event over the handle [1503], etc) and would respond by displaying activated screen locations corresponding to the movement handle (e.g., if the movement handle is on a Train, the activated screen locations could be to archive or delete the Train; if the movement handle is on a file, the activated screen locations could be to add the file to a new Train; etc). The code could also detect if the user drags and drops the movement handle over one of the activated screen locations (e.g., a lbuttonup event over the activated location, etc) and, send the appropriate command to a central server to implement the action associated with the activated screen location (e.g., send a command to archive a Train, etc). Of course, other variations are also possible, and could be implemented by those of ordinary skill in the art without undue experimentation. Accordingly, the discussion of activated screen location display and detection above should be understood as being illustrative only, and not limiting.

Also, it should be noted that, in some implementations, moving a Train or Train element may be implemented in such a way as to leave the Train or Train element's original location undisturbed. That is, a Train element could be moved to a folder without removing it from its Train or any folders it had previously been moved to, and a Train could be moved to a folder without removing it from any folders it had previously been moved to. This could be achieved, for example, by implementing movement to simply add a reference in a database indicating that a Train or Train element should be associated with a folder, or, in cases where folders reflect physical organization of data, by automatically making a copy of the Train or Train element when it is added to a folder. The same approach could also be used when a Train element is copied from one Train to another—instead of making an additional copy of the Train element, or removing it from its additional Train, a database table entry could simply be updated to indicate that the Train element was accessible from the new Train, thereby providing the appearance of the Train element having been moved or copied, without having to expand the processing or bandwidth resources necessary to actually copy or move the element.

It should also be noted that, in some implementations, folders may be configured to be displayed in the same location as items that could potentially be moved into folders. For example, in the interface of FIG. 10a, there is a list of Trains in the same portion of the left hand side of the screen as the list of folders [1502] would be displayed. To account for this, a system based on this disclosure can be implemented so that, when a user clicks and drags a movement handle [1503], the list of folders [1502] will automatically be displayed, thereby allowing any object with a movement handle to be moved to a folder, even if the folders would normally be obscured when that object is being displayed. Of course, it is also possible a system could be implemented so that moving a Train or a Train element into a folder would remove the Train or Train element from its previous location(s). Other variations, such as where a user is prompted as to whether moving a Train or Train element into a folder should remove it from its previous locations are also possible, and will be immediately apparent to those of ordinary skill in the art. Similarly, in some implementations, folders could be associated with functionality beyond operating as a simple organizational tool. For example, in some implementations, a user could be allowed to indicate that another individual should be added as a participant in all Trains in a folder, or to share all Train elements in a folder with another individual automatically (e.g., selecting the individual(s) who should be added as a participant or with whom the elements in a folder should be shared, then activating a “share entire folder” tool to share the contents of the folder or add the individual as a participant to the folder's Trains).

While, as discussed in more detail below, the inventors' technology can be used as a replacement for emails and other tools in online interactions, the inventors' technology can, and preferably will, be implemented in a manner that allows integration with email and other existing tools. For example, in some cases, a system implemented according to this disclosure could allow an individual to import his or her email inbox, and would automatically organize the messages in that inbox into Trains that could support functionality such as described above. This could be done, for example, by using header information in email messages, such as INREPLYTO and MESSAGEID metadata, to trace the trail of an email interaction, then creating a new Train corresponding to the email interaction, where each email message is treated as an update to the new Train, and each participant in the email chain is invited to join as a participant in the new Train. Similarly, in some cases, a user creating a new Train from his or her inbox could be provided with options for creating the Train. For example, rather than automatically inviting each participant in the email chain, the system could provide the user with an interface allowing him or her to choose between adding all participants, adding only those participants who were included in all emails in the chain, or choosing whether to add participants in the email chain to the Train on a participant by participant basis.

Alternatively, rather than creating a new Train from an entire email interaction, it is possible that a system implemented using the inventors' technology could create a new Train for each email provided for inclusion in the system, could create a new Train for each email having the same subject line, or could base the relationships between Trains and emails on some other attribute or combination of attributes. These types of alternative approaches could also be provided as options for a user in a system which, by default, would attempt to recreate an entire email interaction when transforming emails into Trains.

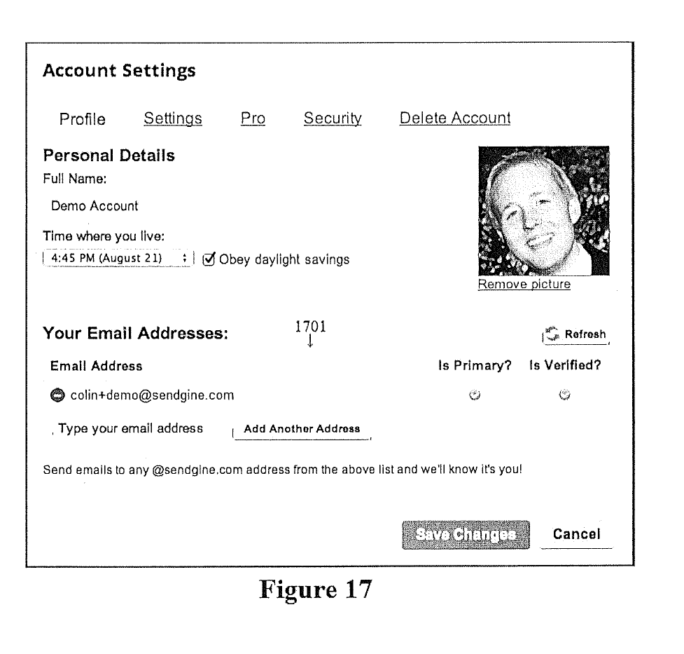

The same types of approaches could also be used to organize emails as they are received, either in addition to, or as an alternative to, allowing a user to import his or her inbox. For example, in some implementations, a user could use an email client to set a forwarding rule so that certain emails received at a particular address would be forwarded to the system implemented using the inventors' technology, or could manually forward certain emails which he or she wanted to be added to the system. When received by the system, such emails could automatically be added to the user's Trains as they come in (e.g., by matching INREPLYTO or MESSAGEID fields with those used in creating existing Trains). In some cases, a system implemented using the inventors' technology could be configured to perform such email integration using an email identification tool [1701] such as shown in FIG. 17. As indicated in that figure, in some cases, a user can be given the opportunity to change the settings for an account used to access a system implemented using the inventors' technology and, in those settings, can be allowed to specify one or more email addresses that will be associated with him or her. Then, if an email is received from one of the specified addresses, the system would know who it should be associated with, and could import it into a Train for that user as described above.

It is also possible that a system implemented using the inventors' technology could include functionality which performed specific actions based on an address to which an email is sent, rather than (or in additional to) the address from which it is received. For example, instead of requiring a response to an email with a Train update to be added to the Train associated with the update, a system implemented according to this disclosure could provide a special purpose email address (e.g., private@system.com) which could be used to make the reply available only to specified recipients, rather than to all participants in the Train. To illustrate, consider a case where a system implemented using the inventors' technology maintained email addresses for three participants in a Train (e.g., user_{—}1@system.com, user_{—}2@system.com, user_{—}3@system.com). If one of the participants in that Train sent an invitation with a Train update to a fourth user at an outside email address (e.g., user_{—}4@outside.com), that fourth user could indicate that a reply to that invitation should only be seen by a specific participant by sending the reply email to that user's email address (e.g., user_{—}1@system.com), and cc′ing the special purpose email address provided by the system (e.g., private@system.com). This could cause the system to, rather than adding the reply to the Train, make the reply available only to the specified user (e.g., by creating a new Train, with only the individual who sent the reply and the individual specified to receive it as participants, and adding the reply to the new Train only). Other types of specified actions could be performed through email rather than using an interface as discussed previously using the same type of approach (e.g., specifying enhanced security for a reply by cc'ing an email such as secure@system.com on the reply), could also be supported, and will be immediately apparent to those of ordinary skill in the art in light of this disclosure. Accordingly, the discussion above should be treated as being illustrative only, and not limiting.

In addition to allowing users to integrate communications received from legacy systems (e.g., email) into a system implemented using the inventors' technology, some implementations may also include features to facilitate outgoing communications with individuals who still rely primarily on email or other legacy communication systems for their interactions. For example, as described in the context of FIG. 18, the inventors' technology can be implemented in such a way that an individual could be invited to join a Train using an email that could include the content of a Train element and could be replied to in exactly the same manner as an email sent from one email client to another. As will be apparent to one of ordinary skill in the art, this same approach could easily be adapted to allow individuals to transparently interact with Trains using tools with which they are already familiar (i.e., email). For example, in some implementations, a user can configure the settings for a Train so that, whenever a new Train element is added, each participant in the Train (other than the participant that added the element) is provided an email update containing the content of that element. Like the email discussed in the context of FIG. 18, these email updates could be replied to in exactly the same way as traditional emails, with those replies automatically being added to the Train that includes the original update. The replies could then be sent to every participant in the Train (except for the participant who posted the reply) thereby enabling the system implemented using the inventors' technology to seamlessly integrate one or more individuals who communicate only via email.

Other approaches to integrating with email are also possible. For example, in some implementations, when an individual receives an email inviting him or her to become a participant in a Train, that individual might be provided with the ability to view all or part of the Train without becoming a participant. This ability might be provided by a “View Train” link included in the email to the potential new participant which, when clicked on, would allow the potential new participant to view the content of the Train, though, until the potential new participant actually accepts the invitation, his or her ability to update the Train (e.g., by adding new files or messages), might be limited to only providing replies to the original email as described above. Other types of restrictions might also be applied to an individual who has not officially accepted an invitation to join a Train. For example, if a Train includes messages with enhanced security, the potential new participant may be prevented from seeing the content of those messages until he or she has provided his or her assent to an agreement which prohibits the potential new participant from unauthorized disclosure of the contents of those messages. Similar approaches could be used at a system level, rather than the level of an individual Train. For example, a potential new participant could be required to assent to a user agreement for a system implementing the inventors' technology and, once he or she had assented to that user agreement, may not have to assent to additional agreements for individual Trains.

Other types of integration are also possible. For example, the inventors' technology could be used to implement a system that could make time-based elements (e.g., events and tasks) available to external calendar programs (e.g., as an ICS subscription). Further, a system using the inventors' technology could be implemented such that, when a new participant is added to a Train, a vcard for that individual (potentially partially redacted, depending on the user's settings) could be sent as an email update. In general, similar approaches to using emails and existing data objects or formats could be used to provide individuals who are participating in Trains but who do not actually use the system implemented based on the inventors' technology (e.g., because they have not agreed to the necessary terms and conditions, or before they are uncomfortable switching from their existing tools) with information similar to the information that would be available to full users. Additionally, or alternatively, in some cases, APIs can be provided by systems implemented using the inventors' technology which would allow developers to create applications which integrate with the system and can be used to perform activities (e.g., searching Trains, starting new Trains, sharing sensitive information in Trains, exporting information from the system, and reacting in real time to events (e.g., Train updates) generated by the system) in response to events in the outside application.

Of course, it should be understood that, while the inventors' technology can be implemented to transparently integrate with existing tools, such transparent integration is not required in systems implemented according to this disclosure. Indeed, even in cases where transparent integration is supported, that support might include the ability to turn the transparent integration off. For example, in some cases, a user might be allowed turn off email notifications for a Train, or to designate a Train as confidential, thereby causing any messages sent to Train participants (e.g., invitations or update emails) to include information stating that a Train had been updated, but not indicating the nature of the update. Similarly, a user might be allowed to apply such protections to individual updates that would otherwise be sent in a transparently integrated manner. For example, when creating an update using an interface such as shown in FIG. 10b, a user could be provided with an enhanced security control [1004] which, when activated, would cause the update to only be viewable by through the system implemented using the technology disclosed herein, rather than also being communicated (e.g., in updates) using other, potentially less secure, technologies (e.g., email).

Such enhanced security might also allow for greater protections than simply not allowing secured content to be communicated using potentially less secure technologies. For example, the discussion of FIG. 18 explained how an individual who was not a user of the system might be allowed to view content, even though he or she might be restricted from updating it. In some cases, for content where enhanced security is applied, this ability of non-users to view the content might be removed, with signing up for, and agreeing to the terms of use of, the system being made mandatory before the secured content would be made available. Indeed, in some cases, even individuals who have agreed to the applicable terms of service might be restricted from viewing secure content in one of their Trains. For example, there could be enhanced security that requires a user to enter a password (which may be the same as, or different from, the password used to log into the system) before being allowed to view secured content. Other features, which may be user transparent (e.g., applying additional encryption to secured content) could also be implemented, and will be apparent to one of ordinary skill in the art in light of this disclosure. Accordingly, the disclosure of enhanced security set forth above, as well as the disclosure of transparent integration that preceded it, should be understood as being illustrative only, and not limiting.

To illustrate how the inventors' technology described above in the context of FIGS. 1-7c and 10a-18 can be used, consider the following illustrations of how the inventors' technology could be applied in various concrete contexts.

As a first illustration, consider the following example of using a Train to facilitate contract negotiation. Initially, a first participant could create a Train and invite a second participant to participate in the Train using a participant entry form [110]. Next, the second participant adds a first draft of the contract being negotiated using the file selection tools [107]. This causes an email notification to be sent to the first participant notifying him or her that the Train has been updated. The first participant then reviews the uploaded draft, and responds by using the message entry tool [106] to update the Train with a request for clarification on a few points in the draft. This results in a notification email being sent out, and the second participant in the Train examining the Train from his or her computer system. However, rather than responding to the questions using the message entry tool [106] or by uploading a new draft contract, in this example the second participant notes that the first participant is still examining the Train, and so invokes the system's real-time chat feature to try and resolve the issues. During the chat, the participants discover that the issues cannot be resolved without input from someone who has a more detailed technical understanding of the underlying subject matter of the contract. As a result, they terminate the real-time chat, and the first participant invites a subject matter expert to become involved in the interaction using the participant entry form [110].

The result of inviting the subject matter expert is that he or she becomes involved in the interaction as a third participant and is immediately given access to the entire Train, including the update with a transcript of the chat session, which was automatically created at the conclusion of that session. Using this information, the third participant identifies an aspect of the second participant's proposal that appears to be unreasonable. Upon being told about this, the first participant becomes incensed and updates the Train with a highly confrontational secure message entered into the message entry tool [106]. While this results in the other participants being sent email notifications that the Train has been updated, neither of them accesses the Train until the first participant has had a change of heart and, because of this change of heart, substantially softens the confrontational message before either of the other participants have a chance to look at it. The second participant then examines the Train, and sees the softened message and that there were no additional participants who could provide subject matter expertise to help resolve the issues with the contract. The second participant then invites his or her own subject matter expert as a fourth participant. The fourth participant then examines the Train, and suggests some modifications to the second participant to try and get past the original issue. The second participant then uploads a new version of the contract that incorporates those suggestions, and later, decides to also add a message explaining the changes from the first version.

Once the first participant gets the email notifying him or her of the update, he accesses the Train and sees that the new version of the contract has been entered. While the second participant had provided a message explaining the changes to the contract, the first participant is still suspicious, and so uses the comparison tool to check and make sure that the changes that were described match the changes that were actually made. Upon seeing that they do, the first participant signs the revised version of the contract, and requests the signature of the second participant. The second participant receives an email with the signature request and adds his or her signature to the document as well. Both the first and second participants then download copies of the Train and the authenticity report, and the first participant locks the Train so that no further editing is possible. The result is that the participants have both an executed contract and a self-contained record of the negotiations that led up to the contract being executed.

As another example of how the inventors' technology could be used, consider the case of an investment in a startup company. In such a case, a venture capitalist (VC) could meet an entrepreneur at a conference and hear an “elevator pitch” for the entrepreneur's company. The VC could then invite the entrepreneur to send the VC a slide presentation and promises to take a meeting with the entrepreneur. They exchange cards, and the VC's contains a handle for a system implemented using the inventors' technology. The entrepreneur sends the VC a Train of Thought with a reference to their meeting and a large file attached (e.g., the presentation in PDF form). The entrepreneur also includes a “to-do”/“task” for scheduling a meeting. Using the system implemented with the inventors' technology, they schedule a meeting which becomes an event on both of their calendars. The VC's associate is included as well by inviting that individual to the Train of Thought before the meeting is scheduled. The morning of the meeting, the VC sees the calendar event and decides to click on the link to the Train of Thought in order to review the conversation and slide deck in preparation.

The meeting is a success and the VC decides to conduct due diligence on the company. The VC starts a new Train of Thought and specifies that the title of the Train of Thought should be “due diligence” to reflect the intended destination for the Train. After creating the Train, the VC uses tools such as discussed previously to add the associate and one or more outside advisors who have relevant expertise. The VC uses the inventors' technology to share the relevant information from the previous Train with the participants in the new Train by dragging the entrepreneur's slide deck from the original Train. The VC also uses the original Train to request additional information and receive it from the entrepreneur. In each case, the VC is able to drag relevant materials from the one Train to the other so the due diligence team can review and comment on them. The VC also locks the participant list of the “due diligence” Train so that their confidential assessment cannot be not accidentally shared. Tasks for the “due diligence” Train (e.g., reviewing a patent application and providing an opinion) are assigned to various participants on the “due diligence” Train, and each of the participants in that Train is provided with the ability to track the progress of the Train based on the completion status of the tasks.

Since due diligence was satisfactory, a new Train of Thought, with a destination of “Close Investment” is created to negotiate the relevant agreements. As this negotiation involves many documents, which may be large files and may be drafts of other files which are already exchanged, file management and version control features of the inventors' technology are used to effectively track and complete the negotiation. Similarly, using task allocation and monitoring as described above for the “due diligence” Train, task functionality provided by the system implemented using the inventor's technology are used to ensure that the negotiations leading to closing continue to progress. Additionally, the VC may, at any time before the “Close Investment” Train is deleted, set (or modify, in the event a deadline had previously been set) a deadline/“arrival time” for the “Close Investment” Train, and the system where the Train is being maintained could allow the participants in the Train to use that deadline to increase their focus on the Train accordingly (e.g., by automatically moving the Train closer to the top of a list of Trains in a central station interface as the deadline approached, and/or allowing the participants in the Train to sort all Trains they were participating in by deadline/“arrival time”).

The inventor's technology can also be used in the facilitation of legal transaction. As an illustration, consider the hypothetical case of Jack, a U.S. citizen, and Jill, a Canadian national, who live in New York and want to adopt a child. To achieve this goal, Jack and Jill can hire Bob in New York to serve as their lawyer. Jack can then start a new Train of Thought with Bob to upload proof of his (i.e., Jack's) citizenship and other important documents so Bob can begin the paperwork. In this process, if Jack becomes concerned that he forgot something, he can add Jill to the Train, which will automatically make everything which had been uploaded to the Train accessible to Jill. Jill, after reviewing the contents of the Train, could tell Jack that he had forgotten to upload a copy of her Canadian passport, and could upload it to the Train using enhanced security (e.g., by toggling an enhanced security control [1004]) so that its contents will not travel via unencrypted email. Bob, like the other participants in the Train, can be allowed to view the passport or any other file in the Train very quickly through a web interface provided by the system maintaining the Train of Thought—first previewing the files, and then downloading local copies only of those files to which he'll need offline access while on vacation at a remote Mexican resort.

In the process of working with Jack and Jill, Bob could then realize that he needs to work with counsel in Canada to understand how the child will be regarded when the couple spends their summers in Canada (e.g., eligible for Canadian health insurance). He begins corresponding with Jill's lawyer, Steve, in Ottawa (for whom he only has an email address), and is able to add him to the existing Train as well, which gives Steve access to all of the data in the Train, and to star those messages in the Train that are most important for Steve to see. Steve sees the email notification and replies (e.g., via hitting a “reply” button in his email client, which reply could be automatically ingested into the Train) that Bob shouldn't be concerned—the child will be covered in Canada—and that the adoption should proceed in the U.S.

Bob could also, in light of this upcoming vacation, ask his associate, Jon, for assistance on the matter, so he adds Jon to the Train, and sets: (1) an event for the initial paperwork filing date of November 1; and (2) a series of tasks for Jon to handle while he (Bob) is out during the month of October. It is very important that the entire adoption process be completed before the end of the year, so Bob also sets the arrival time for the Train to December 31. Jon diligently takes care of every task, which he marks as complete for Bob (or other participants in the Train) to see the next time they access the system. Further, to help ensure that Jon meets the November 1 deadline, the system hosting the Trains can automatically sync that deadline with his local and mobile calendar programs (e.g., via an ICS subscription).

Meanwhile, Jack, having seen Steve and Jon added to the participant list, could decide that there are plenty of people on the case, and so could lock the participant list in order to prevent additional individuals from viewing the Train. He may also learn from Jill that she will want to go back to work in New York when the adoption is complete, and that her application for US citizenship has been approved. To ensure that Jill's old passport information is entirely deleted from the Train by January 31, the point by which the adoption should be completed, he can set a self-destruct timer to destroy the Train by that date. This could result in the system automatically sending warnings of the Train's impending destruction (e.g., a warning 24 hours before the self-destruct timer expires), which warning could cause Bob to download an Authenticity Report of the Train which includes the entire history of the Train (including the contents of all communications in the Train) for his records.

To indicate how this last feature could potentially be applied, consider the case where Jack and Jill travel to Canada, and their adopted child suffers a minor injury requiring a trip to the hospital. In the event that the adopted child was not actually covered by Canadian health insurance, Jack may threaten to sue Bob for malpractice. However, because of the use of the inventors' technology in the interaction, Bob can answer this threat by producing the Authenticity Report showing that he reasonably relied on Steve's advice regarding the foreign healthcare coverage, and by establishing the authenticity of his PDF copy to ensure its integrity.

The inventors' technology can also be used in interactions with medical professionals, and the associated insurance agents. For example, consider the hypothetical case of John Doe, a student living abroad who begins experiencing joint pain. The local doctors could conclude that the issue is bone tissue deterioration and take an MRI of the affected area. The resulting diagnosis could be that a hip replacement is necessary, a surgery that Mr. Doe would like to have back in the United States so that his parent's insurance will cover the costly procedure. Using the inventors' technology, Mr. Doe could send the MRI image (which is likely to be over 50 MB in size) to his parents. The parents could then choose a provider in their area that is covered by their health insurance plan and add the provider's office to the Train of Thought with which John Doe had used to send the MRI image. With the MRI image in hand, the provider could respond with an event to schedule a pre-surgery appointment. Meanwhile, John Doe's parents could start a new Train of Thought with their insurance agent and drag in the MRI image so that it is immediately shared. The insurance agent could upload the paperwork that must be filled out to the Train and could create a to-do for John Doe's parents to submit the information. The original Train of Thought could then continue with information on the surgery as the days unfold, and the insurance Train of Thought could continue for the purpose of filing the appropriate claims and filling out any necessary paperwork.

The inventors' technology could also be used in real estate transactions, such as selling a house. To illustrate this, consider the hypothetical case of Sally Smith and her husband, homeowners planning on selling their house. To do this, they could create a Train of Thought which they could then populate with “to-dos” such as “Weed the yard,” “Hire painters,” and “Have the carpets cleaned.” Some can be assigned to Sally and some can be assigned to her husband, based on who is more capable of completing the task. Items which neither Sally nor her husband is particularly more capable of completing can be left unassigned. Over the weeks as items are taken care of, the two homeowners attach photos of their house and store information about realtors they are interviewing. Once the realtor is selected and the house is ready for the market, a new Train of Thought can be created with their realtor. With a simple select-and-drag action, Sally can pull all of the photos in the original Train to the new Train instantly. With the photos, the realtor can begin the selling process, periodically updating the Train of Thought with information on potential buyers.

The inventors' technology can also be beneficially applied in the field of marketing. As an example, consider the case of Box & Container (B&C), a hypothetical retailer which sells home goods direct to consumers, and Sally, a long-time customer of B&C who is redecorating her home with Joe as a consultant. In this example, B&C had historically sent paper catalogues and email coupons to Sally, but has migrated to a system implemented using the inventors' technology, and now sends Sally a Train of Thought which includes each season's catalogue, which is often over 50 MB and includes high quality photos.

Because of the use of the Train of Thought, instead of receiving multiple emails (which she used to delete), Sally now has a single Train with every catalogue. Even if it is September, she can refer back to a rug she liked the Spring catalogue, and with a single drag-and-drop action (which, as set forth herein, could be accomplished without requiring the overhead of uploading or downloading the dragged and dropped material), she can move the entire catalogue from her B&C Train to her “Redecorating” Train with Joe on copy. Further, B&C can ensure deliverability to Sally (which they couldn't do with email or post), and they can know (down to the precise second) how and when she accesses the content delivered through the Train.

Although Sally can preview the entire catalogue without ever downloading it using the preview option, and she can delete it when she's done, the Train of Thought can also act as an always-on channel. Indeed, in some cases, even if the Train is deleted, it will be resurrected the next time B&C sends a catalog or offer to Sally (assuming that Sally does not unsubscribe from the Train, which action preferably will be reflected in B&C removing Sally from the list of people who should receive updates which might resurrect the Train). Additionally, when Sally later receives information from Big Bank, all of her monthly statements are contained in a cohesive Train. Unlike the catalogues, her statements in the Train can be protected with enhanced security to ensure that previews of her confidential information do no travel via unencrypted email. As a result, both the bank and B&C can now: (1) know that Sally received her information in a timely fashion; (2) know if Sally downloaded, deleted (or both) the information she received; (3) know that the information sent on the Train is afforded an appropriate level of security; and (4) if the Train is deleted, automatically resurrect it and provide the entire back history of communications which took place before the Train was deleted.

Of course, other uses of the inventors' technology, as well as variations on the use cases described above, are possible and could be implemented by those of ordinary skill in the art without undue experimentation in light of this disclosure. For example, while the above use cases described notifications being provided via email, it is equally possible that notifications could be sent via other communication channels, such as via SMS messages, MMS messages, badges (e.g., unread indicators which tag applications in iOS and similar platforms, which will generally fill the entire screen or automatically be hidden depending on the user's preferences), through third-party service providers (e.g., FACEBOOK messages), etc. Accordingly, the use descriptions set forth above should be understood as being illustrative only, and not be treated as limiting.

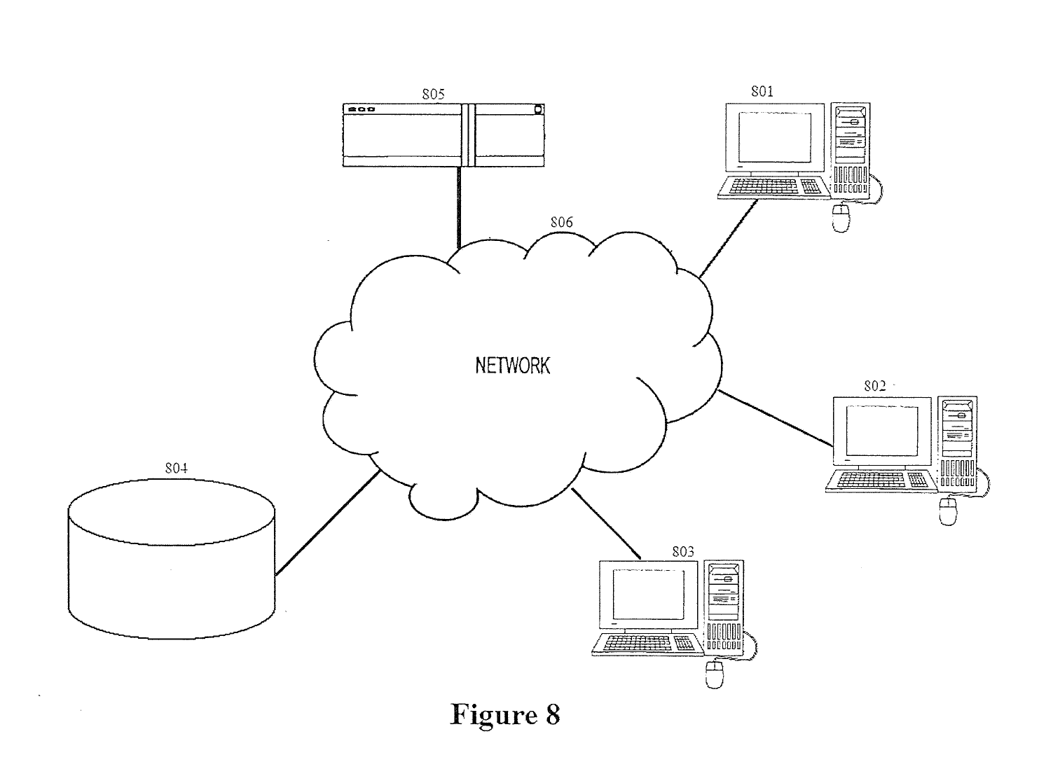

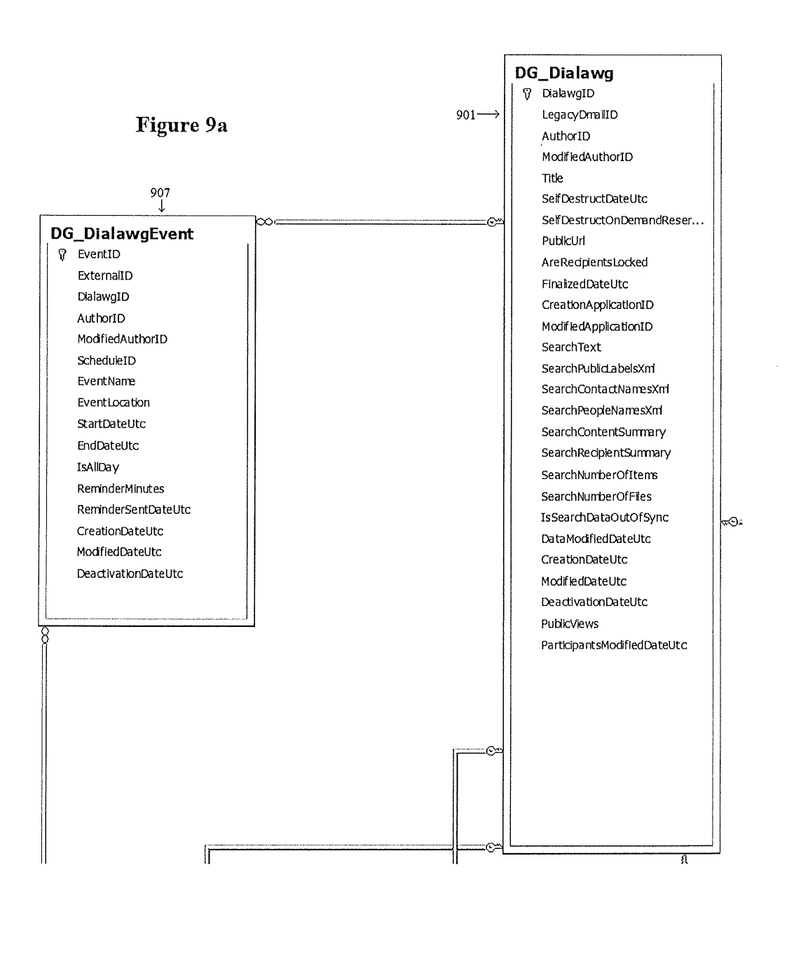

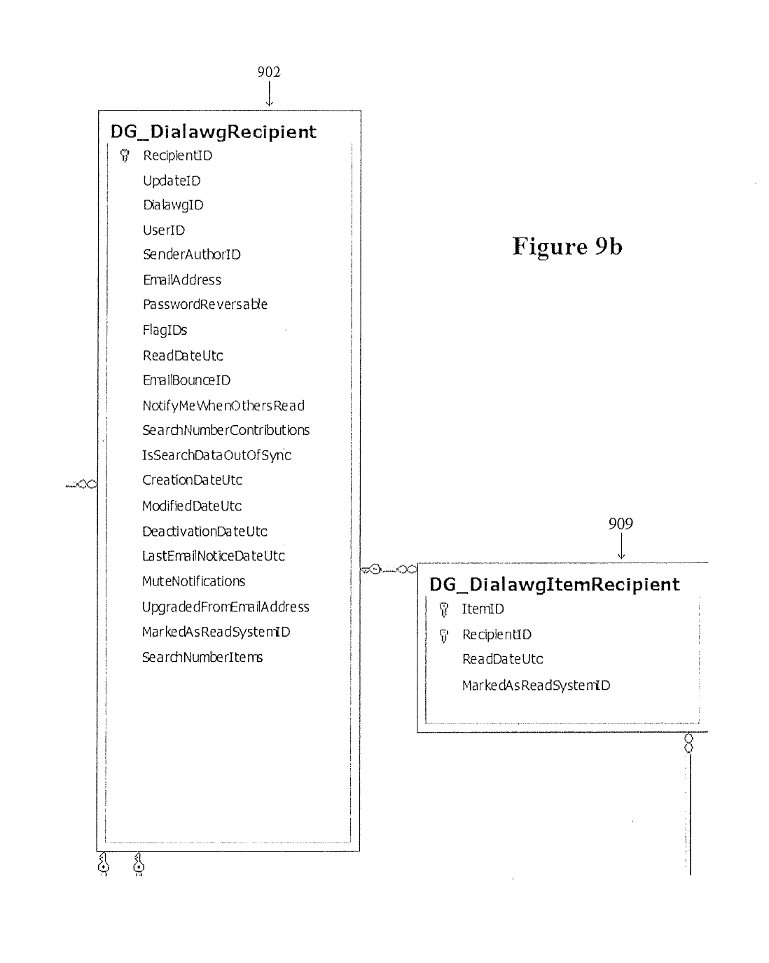

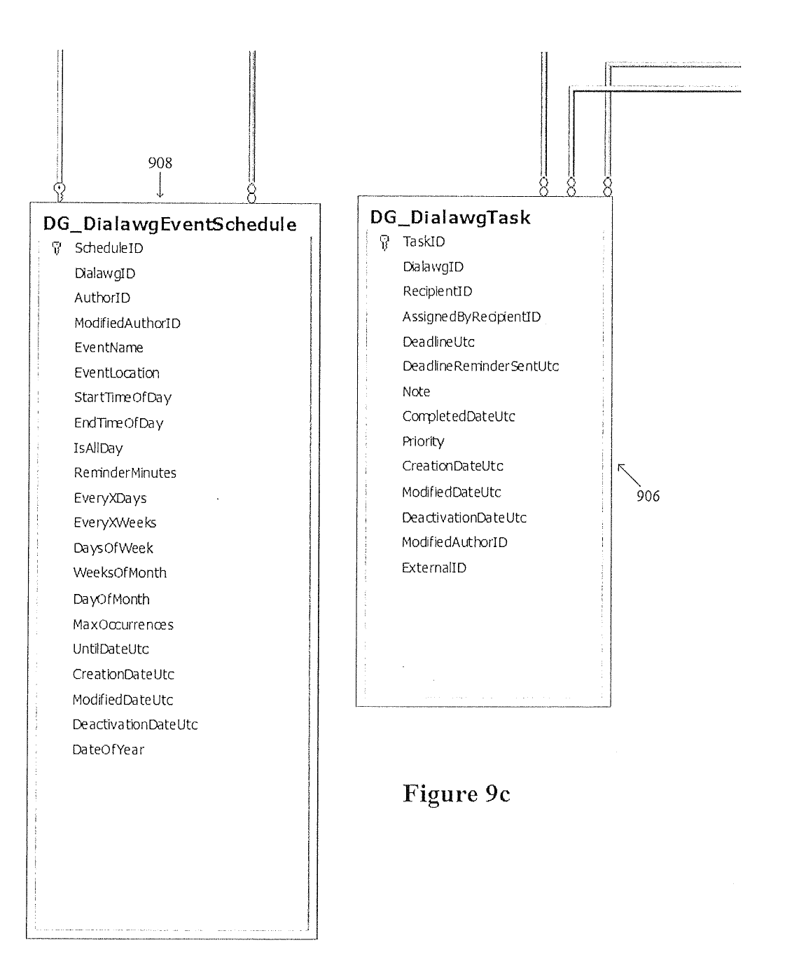

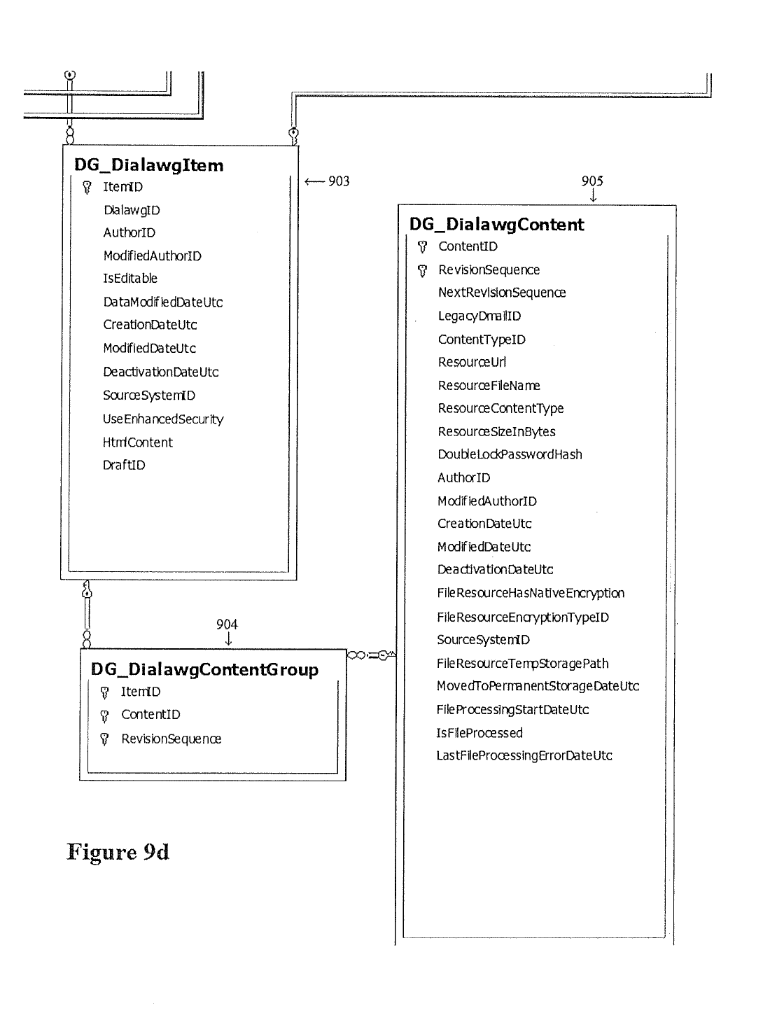

Turning now to FIGS. 8 and 9a-9d, FIG. 8 illustrates an architecture that could be used to support a system that provides functionality such as described herein, while FIGS. 9a-9d depict a set of database tables that can be used to support interaction functionality (FIGS. 9a-9d can be assembled into a single database schema diagram with FIG. 9a in the upper left, FIG. 9b in the upper right, FIG. 9c in the lower left, and FIG. 9d in the lower right). In the architecture of FIG. 8, there is a plurality of client computers (which may be mobile phones, desktop computers, laptop computers, or any other type of network enabled computing device) [801][802][803], which would be used to access interfaces such as discussed previously to interact with the system. For example, a user could use a web browser on a first client computer [801] to access a server [805] storing information necessary to maintain the Trains, and that might also store the information for the Trains themselves, or store some or all of such information (e.g., files uploaded to Trains) in a remote mass storage database [804]. The server [805] could then retrieve a list of Trains the user is participating in using a DialawgRecipient table [902] in a database stored locally with the server [805], and present that list to the user through the browser on the first client computer [801] using an interface such as shown in FIG. 5. Of course, variations on the architecture of FIG. 8 are possible and will be immediately apparent to those of ordinary skill in the art in light of this disclosure. For example, in some cases a server [805] may be accessed via a proprietary application (e.g., a smartphone app), rather than through a browser as described above. Accordingly, the discussion above should be treated as being illustrative only, and not limiting.

When the user selects a Train to examine (e.g., to display on an interface as shown in FIG. 1), the server could then retrieve that Train from the Dialawg table [901]. In that table, the Trains would be stored as rows, and would be connected to messages and files through the DialawgItem table [903], to tasks through the DialawgTask table [906], to events through the DialawgEvent table [907], and to the schedules for repeating events (e.g., daily repetitions, weekly repetitions, monthly repetitions, etc) using a DialawgEventSchedule table [908]. The DialawgItem table [903] would store a message body for an update that was added through the message entry tool [106], and would be associated with data from real-time chats or files through the DialawgContentGroup and DialawgContent tables [904][905]. In those tables, the DialawgContent table [905] would store information from a real-time chat, as well as any files (or references to files on the remote mass storage database [804], depending on the implementation) associated with the update. The DialawgContentGroup table [904] would then be responsible for organizing the individual files and/or message bodies so that multiple files and/or message bodies could be included in a single update. Once a user had examined a message, the DialawgItemRecipient table [909] could be updated to reflect that the message had been read, allowing the system to track that a user may have read messages X and Y, but had not read message Z.

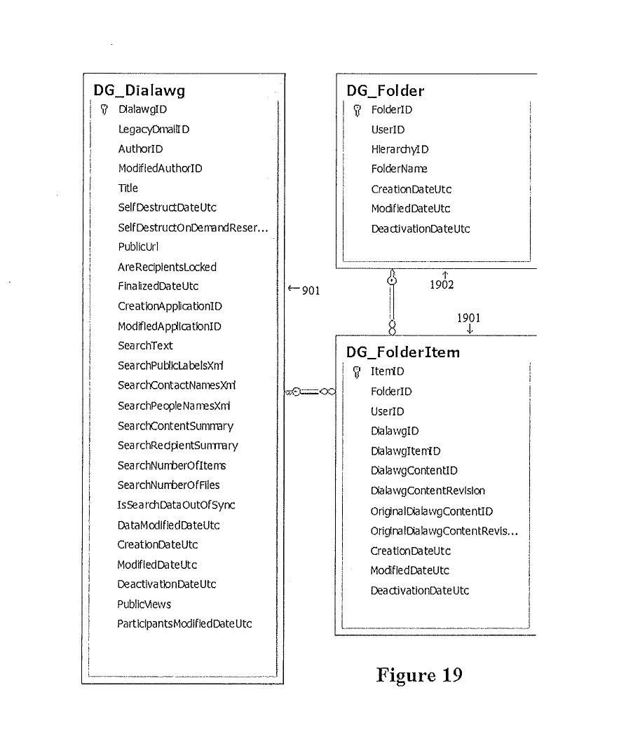

Using this type of architecture, or a different type of architecture (e.g., one where all Train elements are linked to a Dialawg table [901] through a single table, which table is itself linked to additional tables for each type of element) activities such as described previously (e.g., updating Trains, creating new Trains, modifying message in Trains, etc.) could be implemented simply by modifying the tables in the database maintained by the sever [805] using create, read, update and delete commands for relational databases, which are well known to those of ordinary skill in the art. Other tables could also be included as well. For example, as shown in FIG. 19, in implementations of the inventors' technology which allow users to organize Trains and Train elements using folders, there could be a FolderItem table [1901] and a Folder table [1902]. In this type of organization, the FolderItem table [1901] could be similar to the DialawgItem table [903] in that entries in that table could store the same type of information as entries in the DialawgItem table [903], except organized by folder, as opposed to by Train. The Folder table [1902] could then be used to maintain the hierarchy of the folders themselves, and to store information about those folders, such as their creation, modification, and deactivation date.

Also, using a Folder table [1902] and folder item table [1901] as shown in FIG. 19, it is possible that different folders could be maintained for different users with the UserID data element in those tables. For example, in some implementations of the inventors' technology the association of folders with individual users could allow each user to create his or her own hierarchical organization for Trains and Train elements, and such organizations could be kept and maintained in a way which is personal to the individual users in a manner which is invisible to any other users who have access to those Trains or Train elements. Indeed, in some implementations, because a new copy of Train or Train element may not need to be created when the Train or Train element is added to a folder, there would be the potential for using folders to create an unlimited number of personalized, private organizational schemes, while only having a single copy of the underlying data being organized (i.e., regardless of how many people put a Train into a folder, only one copy of the Train would need to be maintained, with the different storage of the Train in the various folders being represented by references to the folders, rather than different copies of the Train). Of course, alternative approaches to representing folders and the organization of items therein could also be implemented. For example, in some cases, rather than having separate DialawgItem [903] and FolderItem [1901] tables, the two types of tables could be combined by adding a FolderID reference to a DialawgItem table [903]. Accordingly, the description of folder organization above, like the description of the tables of FIGS. 9a-9d, should be understood as being illustrative only, and not limiting.

As will also be apparent to those of ordinary skill in the art, utilizing an architecture as discussed in the context of FIGS. 8 and 9a-9d above can allow a user to access a Train from any client computer without having to install any software on such computer beyond a web browser of the type that is widely available and generally pre-installed when a computer system is acquired. However, there are other benefits to using an architecture such as discussed above as well. For example, because interactions in a Train take place through the remote server [805], that server [805] can be used to ensure the security of all communications and data related to the Train. In particular, to ensure security of communications, the server [805] can be configured to require all communications from client computers (e.g., [801][802][803] to take place over secure connections (e.g., by forcing all HTTP connections to redirect to 128-bit SSL HTTPS connections), even if the networks those communications are sent over (e.g., network [806]) are not themselves secure. Further, the server [805] can store information relating to Trains in a secure form as well, such as encrypted form using AES 256-bit encryption. In cases where files for a Train are stored separately from the remainder of the data (e.g., in a remote mass storage database [804]), the same type of security measures can be applied to those files as well.

Additionally, the server [805] can also maintain a variety of tables that are used for auditing data in addition to the tables used to present Trains. For example, the server [805] can maintain additional tables that are used for purposes such as determining when all individuals who have been granted access to a particular file have deleted that file (i.e., no longer have access to any Trains that include that file), or determining if an individual who uploads a file desires to delete that file before any participants in the Train where it was uploaded have tried to read it. Such tables can allow data to be deleted when it is no longer needed, track usage of and access to data, and improve the performance of the overall system, and can have the practical impact of increasing the number of tables used in some embodiments far beyond those shown in FIGS. 9a-9d. Accordingly, neither the database structure of FIGS. 9a-9d, nor the architecture of FIG. 8, should be treated as limiting on the scope of any claims included below or in any documents that claim the benefit of this disclosure.

It should be understood that, while the disclosure set forth herein has provided concrete examples of how the inventors' technology can be implemented and used, those examples are intended to be illustrative only, and variations on the implementations and uses set forth herein are possible. To illustrate this type of variation, consider the functionality of notifying Train participants of updates. In the example of a contract negotiation, participants were sent email messages whenever an update was made to the relevant Train. However, sending email notifications for each update is not a requirement of the inventors' technology, and alternatives are also possible. For example, in some cases, a Train participant could be sent a single message, and his or her client computer could be configured so that the email client on that computer would restore that single message to unread status, and move it to the top of the user's inbox when a new update was made, rather than sending multiple messages that might overwhelm the user's inbox. This could be implemented by installing a small application on the end user's computer, which communicates with the remote server and makes the necessary changes to the user's inbox through an API provided by the email client, or, in the case of IMAP messages by simply changing the message status information (e.g., read flags) without requiring any additional application on the user's device. Of course, combined approaches are also possible, for example, an approach where users are allowed to choose what type of notification they will receive, and even whether they will receive notifications at all, by modifying settings either for the particular Train or in an account maintained by the remote server.

As another example of a type of variation that could be implemented based on the disclosure set forth herein, consider the case where, rather than relying on communication with a remote server, a user accesses Trains using an application installed on his or her own client computer. Such an application might store information for a Train that would otherwise be maintained only on the remote server and/or mass storage database, and could also perform tasks useful in allowing offline access to that information, such as modifying links to files in the Train to point to locations for those files on the user's computer, rather than locations for those files on a mass storage database and/or synchronizing the information on the user's computer with information on the remote server and/or mass storage database. As yet another variation on the disclosure set forth herein, consider the fact that the technology described in this document is susceptible of a variety of uses beyond the negotiation of contracts. For example, given the high security which is made possible by the inventors' technology, it is very well suited to the exchange of information in any context where there are regulatory, business, or other reasons why increased security and/or tight organization or even improved information sharing is necessary (e.g., transmission of personal health information, transmission of credit card data, transmission of industrial designs or other commercially valuable information, maintaining data audit trails for FDA new drug applications, etc.).

In certain embodiments, a user can operate the central station interface to view certain content items in the right-hand pane while seeing a plurality of folders and/or Trains in the left-hand pane. Using interface dynamics that will occur to those skilled in the art in view of this disclosure (such as checkbox controls, contiguous item selection, and “control-clicking” to name just a few), the user can select multiple destination folders/Trains, then associate one or more content items from the right side with each of the multiple destinations using a single action. In some implementations, the action will be a drag-and-drop or other gesture, a keystroke, or other user action as will occur to those skilled in the art in view of the present disclosure.

Further, like the examples set forth in this document, the variations described above are intended only to illustrate the broad applicability and utility of the inventors' technology, and should not be treated as implying limits on the same. Accordingly, instead of limiting the protection accorded by this document, or by any document that is related to this document, to the material explicitly disclosed herein, the protection should be understood to be defined by the claims set forth in this document or the related document. Such claims are drafted to reflect the scope of protection sought by the inventors by the document in which they are incorporated when the terms of those claims listed as having “Explicit Definitions” in this or the related document are given those definitions, and all other terms in the claims are given their broadest reasonable interpretation as shown by a general purpose dictionary. To the extent that the interpretation that would be given to any such claims based on the above disclosure is in any way narrower than the interpretation that would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect.

### EXPLICIT DEFINITIONS

When used in the claims, “based on” should be understood to mean that something is determined at least in part by the thing that it is indicated as being “based on.” When something is completely determined by a thing, it will be described as being “based exclusively on” the thing.

When used in the claims, “computer” should be understood to refer to a device, or group of devices, which is capable of performing one or more logical and/or physical operations on data to produce a result. Non-limiting examples of “computers” include servers, laptops, desktops, NETBOOKS, and notebooks, as well as handheld devices such as cellular phones, personal digital assistants, and portable game consoles.

When used in the claims, “computer executable instructions” should be understood to refer to data that can be used to specify physical or logical operations that can be performed by a computer.

When used in the claims, “computer readable medium” should be understood to refer to any object, substance, or combination of objects or substances, capable of storing data or instructions in a form in which they can be retrieved and/or processed by a device. A computer readable medium should not be limited to any particular type or organization, and should be understood to include distributed and decentralized systems however they are physically or logically disposed, as well as storage objects of systems that are located in a defined and/or circumscribed physical and/or logical space. Computer memory such as hard discs, read only memory, random access memory, solid state memory elements, optical discs and registers is an example of a “computer readable medium.”

When used in the claims, “configured” should be understood to mean that the thing “configured” is adapted, designed or modified for a specific purpose. An example of “configuring” in the context of computers is to provide a computer with specific data (which may include instructions) that can be used in performing the specific acts the computer is being “configured” to do. For example, installing Microsoft WORD on a computer “configures” that computer to function as a word processor, which it does by using the instructions for Microsoft WORD in combination with other inputs, such as an operating system, and various peripherals (e.g., a keyboard, monitor, etc.).

When used in the claims, the term “data object” should be understood to refer to an identifiable and distinct entity expressed in a form (e.g., data stored in a computer readable medium) that can be manipulated by a computer.

When used in the claims, “database” should be understood be to a collection of data stored on a computer readable medium in a manner such that the data can be retrieved by a computer. The term “database” can also be used to refer to the computer readable medium itself (e.g., a physical object that stores the data).

When used in the claims, the verb “display” refers to the act of providing the thing “displayed” in a visually perceptible form. It should be understood that, in the context of this disclosure, “displaying” refers not only to actually physically presenting a thing on a screen, but also to causing that thing to be presented (e.g., by sending instructions from a local CPU, or by sending information over a network that causes a thing to be “displayed”).

When used in the claims, an “element” of a “set” (defined infra) should be understood to refer to one of the things in the “set.”

When used in the claims, “remote” should be understood to refer to the relationship between entities that are physically distant from one another, such as between entities that communicate over a network.

When used in the claims, the term “set” should be understood to refer to a number, group, or combination of zero or more things of similar nature, design, or function.

When used in the claims, the term “storing” used in the context of a memory or computer readable medium should be understood to mean that the thing “stored” is reflected in one or more physical properties (e.g., magnetic moment, electric potential, optical reflectivity, etc.) of the thing doing the “storing” for a period of time, however brief.

Accordingly, what is claimed is:

1. A machine comprising a server; and a computer located remotely from the server, in data communication with the server, and being used by a first user, wherein:
the server is programmed with a set of computer-executable instructions operable to configure the server to:
in response to a request from the computer for a central station interface for the first user, generate a central station interface for the first user and send data specifying the central station interface for the first user to the computer, wherein the central station interface for the first user comprises identifiers for:
one or more trains, in each of which the first user is participating;
one or more tasks, each of which being associated with a train in which the first user is participating, and each of which has “incomplete” or “complete” status;
one or more other users, each of whom is participating in a train in which the first user is participating; and
one or more train elements, each of which is associated with a train in which the first user is participating;
allow the first user to, for each folder from a set of folders associated with the first user, place at least a train element associated with a first train in which the first user is participating into the folder by dragging a representation of the train element to the folder, which does not remove the train element from the first train; and
maintain information identifying each user and each train in which that user is participating; and
a particular user is participating in a train if and only if either the particular user created the train or the particular user was invited to participate in the train by another user who was already participating in the train.

2. The machine of claim 1, wherein the computer-executable instructions are further operable to configure the server to:
generate a train settings interface that includes a participant locking control;
receive a signal indicating actuation of the participant locking control, and
selectively allow participants in the train other than the user who created the train to invite new users to participate in the train based on the activation status of the participant locking control.

3. The machine of claim 2, wherein
the train setting interface is only shown to the user who created the train; and
the computer-executable instructions are further operable to configure the server to generate an alternative train settings interface that does not include the participant locking control and is shown to users who are participating in the train but did not create the train.

4. The machine of claim 1, wherein the computer-executable instructions are further operable to configure the server to:
store locking information associated with the train in a database, where the locking information has either a first value or a second value;
upon request for a train-related display by a user participating in the train, unless the locking information has the first value, present the user an interface operable to allow the user to add a new participant to the train

5. The machine of claim 1, wherein the computer-executable instructions are further operable to configure the server to:
responsively to receiving a first signal indicating that a user participating in the train would like to invite a new user to participate in the train,
check whether the new user is participating in any trains, and
if not, send an electronic message to the new user, wherein the electronic message contains an agreement link, and
receive a second signal that the agreement link has been followed, and responsively
record assent by the new user to terms of service and
associate the new user with the train as a participant.

6. (canceled)

7. The machine of claim 5, wherein
the signal comprises identity information for the new user;
before the sending, the user participating in the train provides credentials for the machine to connect to a third-party service that retains contact information for the new user; and
the sending comprises communicating through the third-party service using the credentials.

8. (canceled)

9. The machine of claim 1, wherein the computer-executable instructions are further operable to configure the server to:
responsive to the posting of an additional train element to the train by the first user, send a notice message to each of the other users participating in the train to provide notice of the posting, where the notice message:
travels through a messaging system not controlled by the machine; and
includes an address for replies that is associated with the train;
accept a reply to the notice message from one of the other users; and
vary the handling of the content of the notice message as a function of the presence and content of one or more recipients of the reply other than the address for replies.

10-13. (canceled)

14. The machine of claim 13, wherein the request for a transcript includes a selection by category of portions of the content for inclusion in the transcript.

15. (canceled)

16. The machine of claim 1, wherein the computer-executable instructions are further operable to configure the server to present a list of the one or more trains filtered as a function of:
the existence of unread train elements associated with each train;
the status of an “archived” property associated with each train;
where each of the one or more trains is associated with an arrival time, whether the arrival time is later than the time the display is generated;
where each of the one or more trains is associated with an arrival time, whether the arrival time is earlier than the time the display is generated;
the existence of incomplete tasks associated with each train;
the existence of future events associated with each train;
the status of a “starred” property associated with each train; or
the status of highlighted text associated with each train.

17. The machine of claim 1, wherein the computer-executable instructions are further operable to configure the server to:
receive a command from the first user to copy a train element associated with a first train into a second train;
respond to the command by associating the train element with the second train without making a physical copy or the train element;
receive a revised version of the train element through an interface associated with the second train;
respond to the receipt of the revised version by associating the revised version with the second train but not with the first train.

18-21. (canceled)

22. A machine for processing a collection of digital content items comprising a server; and a computer located remotely from the server, in data communication with the server, and being used by a first user; wherein the server is programmed with a set of computer-executable instructions operable to configure the server to:
receive a first item of digital content from a first person;
associate the first item with the collection of digital content items and with the first person at a time when the first person is permitted to access the collection, but a second person is not permitted to access the collection;
upon receiving a command from the first person, send an invitation to the second person;
receive a reply to the invitation, where the reply contains a second item of digital content, and automatically associate the second item with the collection and the second person; and
display an item-adding interface for accepting additional items of digital content for addition to the collection, where the second person is not permitted to use the item-adding interface.

23. (canceled)

24. The machine of claim 22, wherein the computer-executable instructions are further
operable to configure the server to:
after the displaying, receive an acceptance of the invitation; and
then automatically permit the second person to access the first consolidated display.

25. The machine of claim 22, wherein the computer-executable instructions are further operable to configure the server to:
after the displaying, receive acceptance of the invitation;
then display the first item, the second item, and an indication of the acceptance in a second consolidated display, where the first person and the second person are each permitted to access the second consolidated display.

26. The machine of claim 22, wherein the computer-executable instructions are further operable to configure the server to:
generate a collection settings interface that includes a participant locking control;
receive a signal indicating actuation of the participant locking control, and
selectively allow participants in the train other than the user who created the train to invite new users to participate in the train based on the activation status of the participant locking control.

27. (canceled)

28. The machine of claim 22, wherein the invitation comprises a reply-to header encoded with information decodable by the server to associate replies to the invitation with the collection of digital content items.

29. The machine of claim 22, wherein,
when the server receives the first item of digital content from the first person, it comprises a security datum selected by the first person; and
the computer-executable instructions are further operable to configure the server to include different amounts of information about the first item of digital content depending on the security datum.

30-34. (canceled)

35. A machine for processing a collection of digital content items comprising: a server; and a computer located remotely from the server, in data communication with the server, and being used by a first user; wherein the server is programmed with a set of computer-executable instructions operable to configure the server to:
form a collection of digital content elements associated with the first user and a second user; and
automatically notifying the second user when the first user adds an additional content item to the collection,
wherein the notification includes or omits data encoding at least a portion of the content as a function of a security property associated with at least one of
the first user;
the second user;
the additional content item; and
the collection.

36. The machine of claim 35, wherein
the security property associated with the first user serves as a default setting for the security property associated with the additional content item; and
the function is configured such that the security property associated with the additional content item controls the inclusion or omission of data.

37. The machine of claim 35, wherein
the security property associated with the collection serves as a default setting for the security property associated with the additional content item; and
the function is configured such that the security property associated with the additional content item controls the inclusion or omission of data.

38. The machine of claim 35, wherein the function is configured such that data encoding the at least a portion of the content is omitted from the notification if the security property associated with the collection indicates heightened security, regardless of the security properties associated with the first user, the second user, and the additional content item.

39-42. (canceled)
